(19) United States
(12) Patent Application Publication
(10) Pub. No.: US 2022/0040978 A1
(43) Pub. Date: Feb. 10, 2022

(54) INKJET PRINTING DEVICE AND PRINTING METHOD USING THE SAME

(71) Applicant: Samsung Display Co., Ltd., Yongin-si (KR)

(72) Inventors: Heung Cheol JEONG, Hwaseong-si (KR); Do Hun LEE, Seoul (KR); Myung Soo HUH, Suwon-si (KR); Byung Chul LEE, Hwaseong-si (KR)

(21) Appl. No.: 17/444,348

(22) Filed: Aug. 3, 2021

(30) Foreign Application Priority Data
Aug. 6, 2020 (KR) 10-2020-0098639

(51) Int. Cl. B41J 2/165

(52) U.S. Cl. CPC B41J 2/1652

(57) ABSTRACT

An inkjet printing and an inkjet printing method are provided. The inkjet printing device includes a stage comprising a substrate mounting part configured to receive a target substrate mounted thereon, a print head unit located above the stage and configured to spray an ink including a plurality of particles, and a suction device located at a side of the substrate mounting part and configured to generate negative pressure thereon.

### CROSS-REFERENCE TO RELATED APPLICATION

This application claims priority to and the benefit of Korean Patent Application No. 10-2020-0098639, filed on Aug. 6, 2020, in the Korean Intellectual Property Office, the disclosure of which is incorporated herein by reference in its entirety.

### BACKGROUND

### 1. Field

The present disclosure relates to an inkjet printing device and a printing method using the same.

### 2. Description of the Related Art

Display devices are becoming increasingly important with the development of multimedia. Accordingly, various types of display devices such as organic light emitting displays and liquid crystal displays are being used.

A display device is a device for displaying an image and includes a display panel such as an organic light emitting display panel or a liquid crystal display panel. As a light emitting display panel, the display panel may include light emitting elements such as light emitting diodes (LEDs). For example, the LEDs may be organic light emitting diodes (OLEDs) using an organic material as a light emitting material or may be inorganic LEDs using an inorganic material as the light emitting material.

An inkjet printing device may be used to form an organic material layer included in a display device or align inorganic LEDs. After an ink or solution is inkjet-printed, a post-processing process may be performed to transfer the inorganic LEDs or form the organic material layer. In the inkjet printing device, a suitable ink or solution (e.g., a set or predetermined ink or solution) may be supplied to an inkjet head, and the inkjet head may perform a process of spraying the ink or solution onto a substrate to be processed (e.g., a target substrate).

### SUMMARY

Embodiments of the present disclosure provide an inkjet printing device which makes the number of particles in ink sprayed at the initial time of a printing process uniform, irrespective of the settling of the remaining ink particles in an inkjet head during a printing standby time.

Embodiments of the present disclosure also provide an ink spraying method in which the quality of sprayed ink is maintained even when a printing standby time is included in a printing process.

However, aspects of the embodiments of the present disclosure are not restricted to the one set forth herein. The above and other aspects of the present disclosure will become more apparent to one of ordinary skill in the art to which the present disclosure pertains by referencing the detailed description of the present disclosure given below.

An inkjet printing device according to an embodiment includes a suction device and a preliminary jetting part. Thus, it can suck a plurality of particles remaining in a nozzle of an inkjet head before a printing process is performed and pre-jet ink a set number of times to make the number of particles included in each droplet of ink jetted uniform. Therefore, when ink is sprayed onto a target substrate using the inkjet printing device, ink with uniform quality can be sprayed, thereby improving the reliability of a device manufactured using the inkjet printing device.

However, the aspects of the embodiments are not restricted to the one set forth herein. The above and other aspects of the embodiments will become more apparent to one of daily skill in the art to which the embodiments pertain by referencing the claims.

According to an embodiment of the present disclosure, there is provided an inkjet printing device including: a stage including a substrate mounting part configured to receive a target substrate mounted thereon; a print head unit located above the stage and configured to spray an ink including a plurality of particles; and a suction device located at a side of the substrate mounting part and configured to generate negative pressure thereon.

In an embodiment, the inkjet printing includes a moving unit to adjust relative positions of the print head unit and the stage, wherein the moving unit is configured to adjust a relative position of the print head unit between above the suction device and above the substrate mounting part.

In an embodiment, the suction device is configured to be driven when the print head unit is positioned above the suction device to generate negative pressure between the suction device and the print head unit.

In an embodiment, at least some of the particles in the ink remaining in the print head unit are sucked into the suction device when the suction device is driven.

In an embodiment, suction of the particles by the suction device is performed in a non-spray mode of the print head unit.

In an embodiment, the suction of the particles by the suction device is performed while the relative positions of the print head unit and the stage are fixed.

In an embodiment, the inkjet printing includes a preliminary jetting area located between the substrate mounting part and the suction device.

In an embodiment, the preliminary jetting area is located on the stage and spaced from the substrate mounting part.

In an embodiment, the preliminary jetting area includes an absorption pad to absorb the ink.

In an embodiment, the inkjet printing includes a dummy area located between the substrate mounting part and the preliminary jetting area.

In an embodiment, the dummy area is located on the stage and spaced from the substrate mounting part.

In an embodiment, the dummy area includes a dummy part including a first roll, a second roll spaced from the first roll, and a dummy film wound around the first roll and the second roll and configured to move according to a rotation of the first roll and the second roll, where the print head unit is to spray the ink onto the dummy film.

According to another embodiment of the present disclosure, there is provided an inkjet printing method including: mounting a target substrate on a substrate mounting part of a stage; performing suction of at least some of a plurality of particles in an ink remaining in a print head unit in a state where the print head unit configured to spray the ink including the particles is located above a side of the substrate mounting part not overlapping the substrate mounting part; and spraying the ink including the particles onto the target substrate by changing relative positions of the stage and the print head unit so that the print head unit is positioned above the target substrate.

In an embodiment, the suction of the particles is performed using a suction device located at a side of the substrate mounting part and configured to generate negative pressure thereon.

In an embodiment, the inkjet printing method includes pre-jetting the ink including the particles to a preliminary jetting area located between the substrate mounting part and the suction device, wherein the pre-jetting of the ink is performed between the suction of the particles and the spraying of the ink onto the target substrate.

In an embodiment, the preliminary jetting area is located on the stage and spaced from the substrate mounting part.

In an embodiment, the inkjet printing method includes inspecting the ink sprayed from the print head unit, wherein the inspecting of the ink is performed between the pre-jetting of the ink and the spraying of the ink onto the target substrate.

In an embodiment, the inspecting of the ink includes spraying the ink including the particles to a dummy area located between the substrate mounting part and the preliminary jetting area and inspecting the ink sprayed to the dummy area.

In an embodiment, the suction of the particles is performed in a non-spray mode of the print head unit.

In an embodiment, the suction of the particles is performed while the relative positions of the print head unit and the stage are fixed.

An inkjet printing device according to an embodiment includes a suction device and a preliminary jetting part. Thus, it can suck a plurality of particles remaining in a nozzle of an inkjet head before a printing process is performed and pre-jet ink a set number of times (e.g., a predetermined number of times) to make the number of particles included in each droplet of ink jetted uniform. Therefore, when ink is sprayed onto a target substrate using the inkjet printing device, ink with uniform quality can be sprayed, thereby improving the reliability of a device manufactured using the inkjet printing device.

However, the aspects of the embodiments are not restricted to the one set forth herein. The above and other aspects of the embodiments will become more apparent to one of daily skill in the art to which the embodiments pertain by referencing the claims.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic plan view of a display device according to an embodiment;

FIG. 2 is a plan view of a pixel of the display device of FIG. 1 according to an embodiment;

FIG. 3 is a cross-sectional view taken along the line III-III′ of FIG. 2;

FIG. 4 is a schematic cutaway view of a light emitting element according to an embodiment;

FIG. 5 is a schematic perspective view of an inkjet printing device according to an embodiment;

FIG. 6 is a partial plan view of the inkjet printing device of FIG. 5 according to an embodiment;

FIG. 7 is a plan view of a stage unit according to an embodiment;

FIG. 8 is a schematic view of a stage unit, an ink collecting part, and an ink providing part according to an embodiment;

FIG. 9 is a schematic cross-sectional view of an inkjet head according to an embodiment;

FIG. 10 is a schematic cross-sectional view of a first suction device and an ink collecting part according to an embodiment;

FIG. 11 is a plan view of an example of a suction body of the first suction device of FIG. 10;

FIG. 12 is a schematic cross-sectional view of a first preliminary jetting part according to an embodiment;

FIG. 13 is a partial cross-sectional view of an inkjet head at a first printing standby time according to an embodiment;

FIG. 14 is a partial cross-sectional view of the inkjet head of FIG. 13 at a second printing standby time;

FIG. 15 is a flowchart illustrating a printing method using an inkjet printing device according to an embodiment;

FIGS. 16-30 are plan views, cross-sectional views, and enlarged views schematically illustrating the printing method using the inkjet printing device used in the method of FIG. 15 according to an embodiment;

FIG. 31 is a graph illustrating a process time according to a relative position between a print head unit and each area of the stage unit in a printing process performed using the inkjet printing device used in the method of FIG. 15 according to an embodiment;

FIGS. 32-45 are plan views schematically illustrating a printing process performed using the inkjet printing device used in the method of FIG. 15 according to an embodiment;

FIG. 46 is a schematic plan view of an inkjet printing device according to an embodiment;

FIG. 47 is a schematic plan view illustrating a part of a printing process performed using the inkjet printing device of FIG. 46;

FIG. 48 is a schematic cross-sectional layout view illustrating an example of a first inspection unit and a first dummy part of the inkjet printing device of FIG. 46;

FIG. 49 is a schematic view illustrating ink coated on the first dummy part according to an embodiment;

FIG. 50 is a schematic cross-sectional layout view illustrating an example of the first dummy part of FIG. 46;

FIG. 51 is a graph illustrating a process time according to a relative position between a print head unit and each area of a stage unit in a printing process performed using the inkjet printing device of FIG. 46;

FIG. 52 is a schematic plan view of an inkjet printing device according to an embodiment;

FIG. 53 is a schematic plan layout view of second inspection units and an inspection stage unit of the inkjet printing device of FIG. 52;

FIG. 54 is a schematic cross-sectional layout view of the second inspection units and the inspection stage unit of the inkjet printing device of FIG. 52;

FIG. 55 is a plan layout view of a first suction device and a print head unit according to an embodiment;

FIG. 56 is a plan layout view of a first suction device and a print head unit according to an embodiment; and

FIGS. 57-59 are plan views illustrating various examples of suction holes formed in a suction body.

### DETAILED DESCRIPTION

The present disclosure will now be described more fully hereinafter with reference to the accompanying drawings, in which embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the present disclosure to those skilled in the art.

It will also be understood that when a layer is referred to as being “on” another layer or substrate, it can be directly on the other layer or substrate, or intervening layers may also be present. In contrast, when an element is referred to as being “directly on” another element, there are no intervening elements present.

The same reference numbers indicate the same components throughout the specification. In the attached figures, the thickness of layers and regions is exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the scope of the present disclosure.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that such spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the present disclosure. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present disclosure refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

In some embodiments, one or more outputs of the different embodiments of the methods and systems of the present disclosure may be transmitted to an electronics device coupled to or having a display device for displaying the one or more outputs or information regarding the one or more outputs of the different embodiments of the methods and systems of the present disclosure.

Hereinafter, embodiments will be described with reference to the attached drawings.

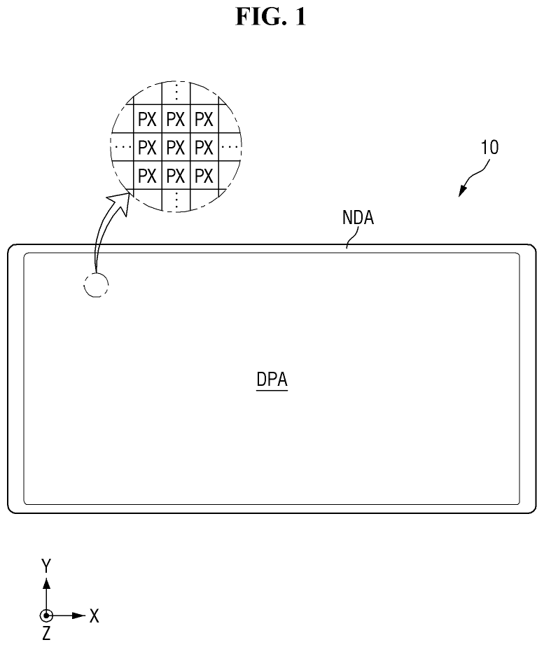

FIG. 1 is a schematic plan view of a display device 10 according to an embodiment.

Referring to FIG. 1, the display device 10 displays moving images and/or still images. The display device 10 may refer to any electronic device that provides a display screen. Examples of the display device 10 may include televisions, notebook computers, monitors, billboards, the Internet of things (IoT), mobile phones, smartphones, tablet personal computers (PCs), electronic watches, smart watches, watch phones, head mounted displays, mobile communication terminals, electronic notebooks, electronic books, portable multimedia players (PMPs), navigation devices, game machines, digital cameras and camcorders, all of which provide a display screen.

The display device 10 includes a display panel that provides a display screen. Examples of the display panel include inorganic light emitting diode (LED) display panels, organic light emitting display panels, quantum dot light emitting display panels, plasma display panels, and field emission display panels. A case where an inorganic LED display panel is applied as an example of the display panel will be described below, but the present disclosure is not limited to this case, and other display panels can also be applied as long as the same technical spirit is applicable.

In the drawings for describing the display device 10, an X-axis direction X, a Y-axis direction Y, and a Z-axis direction Z are defined. The X-axis direction X and the Y-axis direction Y may be directions perpendicular to each other in one plane. The Z-axis direction Z may be a direction perpendicular to the plane in which the X-axis direction X and the Y-axis direction Y are located. The Z-axis direction Z is perpendicular to each of the X-axis direction X and the Y-axis direction Y. In the embodiment of FIG. 1 which illustrates the display device 10, the Z-axis direction Z indicates a thickness direction of the display device 10.

The display device 10 may have a rectangular shape including long sides and short sides, that is, may be longer in the X-axis direction X than in the Y-axis direction Y in a plan view. Corners at which the long and short sides of the display device 10 meet may be right-angled in a plan view. However, the present disclosure is not limited thereto, and the corners may also be rounded. The shape of the display device 10 is not limited to the above example and may also be variously changed. For example, the display device 10 may also have other planar shapes such as a square, a quadrangle with rounded corners (vertices), other polygons, and a circle.

A display surface of the display device 10 may be disposed on a side of the Z-axis direction Z which is the thickness direction. In some embodiments, unless otherwise mentioned, “above” indicates the side of the Z-axis direction Z and a display direction, and an “upper surface” indicates a surface facing the side of the Z-axis direction Z. In some embodiments, “below” indicates the other side of the Z-axis direction Z and a direction opposite to the display direction, and a “lower surface” indicates a surface facing (or opposite to) the other side of the Z-axis direction Z. In some embodiments, “left,” “right,” “upper,” and “lower” indicate directions when the display device 10 is seen in a plan view. For example, “right” indicates a side of the X-axis direction X, “left” indicates the other side of the X-axis direction X, “upper” indicates a side of the Y-axis direction Y, and “lower” indicates the other side of the Y-axis direction Y.

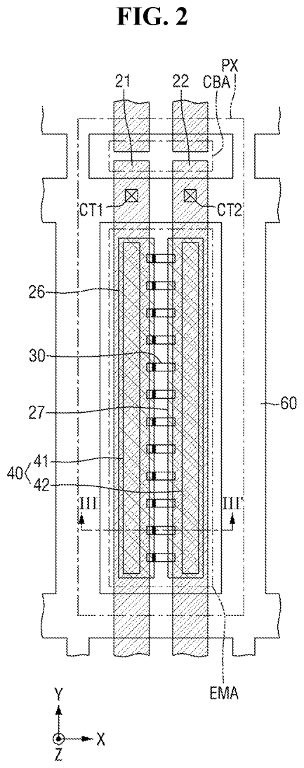

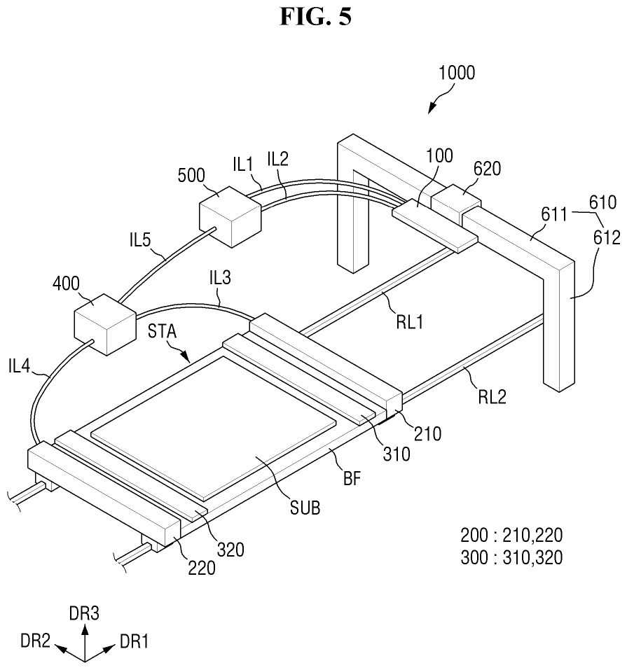

The display device 10 may include a display area DPA and a non-display area NDA. The display area DPA may be an area where an image or images can be displayed, and the non-display area NDA may be an area where no image or images are displayed. The display area DPA may be an area to which light emitting elements 30 (see FIG. 2) are sprayed during a process of manufacturing the display device 10 using an inkjet printing device 1000 (see FIG. 5) to be described later.

The shape of the display area DPA may follow the shape of the display device 10. For example, the display area DPA may have a rectangular planar shape similar to the overall shape of the display device 10. The display area DPA may generally occupy the center of the display device 10.

The display area DPA may include a plurality of pixels PX. The pixels PX may be arranged along rows and columns of a matrix. Each of the pixels PX may be rectangular or square in a plan view. Each of the pixels PX may include light emitting elements made of inorganic particles. The light emitting elements may be placed in each pixel PX through an inkjet printing process performed by the inkjet printing device 1000 (e.g., see FIG. 5). This will be described in detail later.

The non-display area NDA may be disposed around the display area DPA. The non-display area NDA may entirely or partially surround the display area DPA along the edge or periphery of the display area DPA. The non-display area NDA may form a bezel of the display device 10.

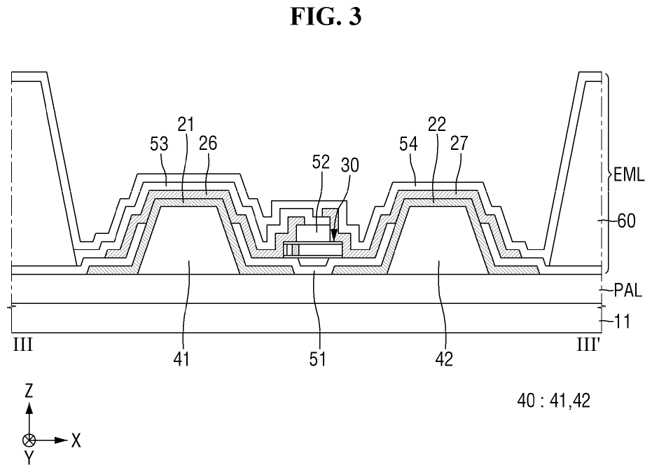

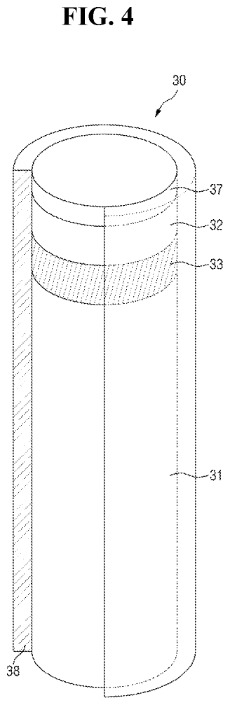

FIG. 2 is a plan view of a pixel PX of the display device 10 according to an embodiment of FIG. 1. FIG. 3 is a cross-sectional view taken along the line III-III′ of FIG. 2. FIG. 4 is a schematic cutaway view of a light emitting element 30 according to an embodiment.

Referring to FIG. 2, each pixel PX of the display device 10 may include an emission area EMA and a non-emission area. The emission area EMA may be an area from which light emitted from light emitting elements 30 is output, and the non-emission area may be an area from which no light is output because light emitted from the light emitting elements 30 does not reach this area.

The emission area EMA may include an area where the light emitting elements 30 are disposed and an area adjacent thereto. In some embodiments, the emission area EMA may further include an area from which light emitted from the light emitting elements 30 is output after being reflected or refracted by other members.

Each pixel PX may further include a cut area CBA disposed in the non-emission area. The cut area CBA may be disposed on a side of the emission area EMA in the Y-axis direction Y. The cut area CBA may be disposed between the emission areas EMA of pixels PX neighboring each other in the Y-axis direction Y. For example, the cut area CBA may be located between adjacent emission areas EMA of the pixels PX that are adjacent to each other in the Y-axis direction Y.

The cut area CBA may be an area where electrodes 21 and 22 included in pixels PX neighboring each other along the Y-axis direction Y are separated from each other. The electrodes 21 and 22 disposed in each pixel PX may be separated in the cut area CBA from their counterparts disposed in a neighboring pixel PX in the Y-axis direction Y, and parts of the electrodes 21 and 22 disposed in each pixel PX may be disposed in the cut area CBA. The light emitting elements 30 may not be disposed in the cut area CBA.

Referring to FIGS. 2 and 3, the display device 10 may include a first substrate 11, a circuit element layer PAL disposed on the first substrate 11, and a light emitting layer EML disposed on the circuit element layer PAL. The light emitting layer EML may include first and second electrodes 21 and 22, first and second contact electrodes 26 and 27, a first bank 40 (e.g., the first bank 40 includes first and second sub banks 41 and 42), a second bank 60, a plurality of insulating layers 51-54, and the light emitting elements 30.

The first substrate 11 may be an insulating substrate. The first substrate 11 may be made of an insulating material such as glass, quartz, or polymer resin. The first substrate 11 may be a rigid substrate, but may also be a flexible substrate that can be bent, folded, rolled, etc.

The circuit element layer PAL may be disposed on the first substrate 11. The circuit element layer PAL may include at least one transistor, etc., to drive the light emitting layer EML.

The first bank 40 may extend in the Y-axis direction Y in each pixel PX in a plan view. The first bank 40 may include first and second sub banks 41 and 42 spaced from each other in the X-axis direction X. A space formed by the first and second sub banks 41 and 42 that are spaced from each other may provide an area where the light emitting elements 30 are disposed.

At least a part of each of the first and second sub banks 41 and 42 may protrude from an upper surface of the first substrate 11 or an upper surface of the circuit element layer PAL. The protruding part of each of the first and second sub banks 41 and 42 may have inclined side surfaces. The first and second sub banks 41 and 42 including the inclined side surfaces may change the direction of light emitted from the light emitting elements 30 and traveling toward the side surfaces of the first and second sub banks 41 and 42 to an upward direction (i.e., the display direction) or to the Z-axis direction Z.

The first and second electrodes 21 and 22 may be disposed on the first and second sub banks 41 and 42, respectively. The first and second electrodes 21 and 22 may be spaced from each other.

Each of the first electrode 21 and the second electrode 22 may extend in the Y-axis direction Y in a plan view. The first electrode 21 and the second electrode 22 may face each other (or may be opposite to each other) in the X-axis direction X.

The first electrode 21 may extend in the Y-axis direction Y in a plan view to overlap parts of the second bank 60 which extend in the X-axis direction X. The first electrode 21 may be electrically connected to the circuit element layer PAL through a first contact hole CT1.

The second electrode 22 may extend in the Y-axis direction Y in a plan view to overlap the parts of the second bank 60 which extend in the X-axis direction X. The second electrode 22 may be electrically connected to the circuit element layer PAL through a second contact hole CT2.

Each of the first and second electrodes 21 and 22 may be electrically connected to the light emitting elements 30, and a voltage (e.g., a set or predetermined voltage) may be applied to each of the first and second electrodes 21 and 22 so that the light emitting elements 30 can emit light. For example, the electrodes 21 and 22 may be electrically connected to the light emitting elements 30 disposed between the first and second electrodes 21 and 22 through the first and second contact electrodes 26 and 27 to be described later and may transmit received electrical signals to the light emitting elements 30 through the contact electrodes 26 and 27.

A first insulating layer 51 may be disposed on the electrodes 21 and 22. The first insulating layer 51 may be disposed on the first electrode 21 and the second electrode 22 and may expose at least a part of each of the first and second electrodes 21 and 22. The first insulating layer 51 may protect the first and second electrodes 21 and 22 while insulating them from each other. In some embodiments, the first insulating layer 51 may prevent the light emitting elements 30 disposed on the first insulating layer 51 from directly contacting other members of light emitting layer EML and the circuit element layer PAL, and thus may prevent the light emitting elements 30 from being damaged.

The second bank 60 may be disposed on the first insulating layer 51. The second bank 60 may include parts extending in the X-axis direction X and the Y-axis direction Y to form a lattice pattern in a plan view. The second bank 60 may be formed to have a greater height than the first bank 40. During the process of manufacturing the display device 10, ink in which the light emitting elements 30 are dispersed may be sprayed to an area defined by the second bank 60 in a printing process using the inkjet printing device 1000 to be described later. The second bank 60 may prevent the ink from overflowing to adjacent pixels PX during the process of manufacturing the display device 10 using the inkjet printing device 1000.

In the printing process of spraying the ink in which the light emitting elements 30 are dispersed to the area defined by the second bank 60 using the inkjet printing device 1000, if the number of light emitting elements 30 included in the ink sprayed to each pixel PX varies greatly from pixel to pixel, the display performance of each pixel PX of the display device 10 may also vary greatly between the pixels. In this case, the reliability of the display device 10 may deteriorate. Therefore, maintaining an uniformity in the number of light emitting elements 30 included in the ink sprayed to each pixel PX may improve the reliability of the display device 10.

The light emitting elements 30 may be disposed on the first insulating layer 51 between the first and second electrodes 21 and 22. The light emitting elements 30 may extend in a direction (e.g., in the X-axis direction X). In some embodiments, the light emitting elements 30 may extend in a direction (e.g., in the X-axis direction X), and the direction (e.g., the Y-axis direction Y) in which each of the first and second electrodes 21 and 22 extend and the direction (e.g., the X-axis direction X) in which the light emitting elements 30 extend may be substantially perpendicular to each other.

A second insulating layer 52 may be partially disposed on the light emitting elements 30 located between the first electrode 21 and the second electrode 22. The second insulating layer 52 may partially cover outer surfaces of the light emitting elements 30. The second insulating layer 52 may be disposed on the light emitting elements 30 but may expose both ends of each of the light emitting elements 30. The second insulating layer 52 may protect the light emitting elements 30 while fixing the light emitting elements 30 during the manufacturing process of the display device 10.

The first and second contact electrodes 26 and 27 may be disposed on the second insulating layer 52. The first and second contact electrodes 26 and 27 may extend in a direction in a plan view. Each of the first contact electrode 26 and the second contact electrode 27 may extend in the Y-axis direction Y. The first contact electrode 26 and the second contact electrode 27 may be spaced to face each other in the X-axis direction X (e.g., the first contact electrode 26 and the second contact electrode 27 may be opposite to each other in the X-axis direction X).

The first and second contact electrodes 26 and 27 may contact the light emitting elements 30 and the first and second electrodes 21 and 22. The first contact electrode 26 may be disposed on the first electrode 21, and the second contact electrode 27 may be disposed on the second electrode 22. The first contact electrode 26 and the second contact electrode 27 may contact a first end and a second end of each light emitting element 30 while partially covering upper surfaces of the first electrode 21 and the second electrode 22.

The first end of each of the light emitting elements 30 exposed by the second insulating layer 52 may be electrically connected to the first electrode 21 through the first contact electrode 26, and the second end of each of the light emitting elements 30 may be electrically connected to the second electrode 22 through the second contact electrode 27.

A third insulating layer 53 may be disposed on the first contact electrode 26. The third insulating layer 53 may electrically insulate the first contact electrode 26 and the second contact electrode 27 from each other. The third insulating layer 53 may cover the first contact electrode 26 but may not be disposed on the second ends of the light emitting elements 30 so that the light emitting elements 30 can contact the second contact electrode 27.

The second contact electrode 27 is disposed on the second electrode 22, the second insulating layer 52, and the third insulating layer 53. The second contact electrode 27 may contact the second ends of the light emitting elements 30 and the exposed upper surface of the second electrode 22. The second ends of the light emitting elements 30 may be electrically connected to the second electrode 22 through the second contact electrode 27.

A fourth insulating layer 54 may be entirely disposed on the first substrate 11. For example, fourth insulating layer 54 may cover the third insulating layer 53, the second contact electrode 27, the first insulating layer 51, and the second bank 60. The fourth insulating layer 54 may protect members disposed on the first substrate 11 from the external environment.

Referring to FIG. 4, a light emitting element 30 may be a particulate element and may be shaped like a rod or a cylinder having an aspect ratio (e.g., a set or predetermined aspect ratio). A length of the light emitting element 30 may be greater than a diameter of the light emitting element 30, and the aspect ratio of the light emitting element 30 may be, but is not limited to, 3:1 to 10:1.

The light emitting element 30 may have a nanometer-scale size (1 nm to less than 1 μm) or a micrometer-scale size (1 μm to less than 1 mm). In an embodiment, both the diameter and length of the light emitting element 30 may have a nanometer-scale size or a micrometer-scale size. In some embodiments, the diameter of the light emitting element 30 may have a nanometer-scale size, whereas the length of the light emitting element 30 has a micrometer-scale size. In some embodiments, some of a plurality of light emitting elements 30 may have a nanometer-scale size in diameter and/or length, whereas the other ones of the light emitting elements 30 have a micrometer-scale size in diameter and/or length.

In an embodiment, the light emitting element 30 may be an inorganic LED. For example, the light emitting element 30 may include a semiconductor layer doped with impurities of any conductivity type (e.g., a p type or an n type). The semiconductor layer may receive an electrical signal from an external power source and emit it as light of a specific wavelength band.

The light emitting element 30 according to an embodiment may include a first semiconductor layer 31, an active layer 33, a second semiconductor layer 32, and an electrode layer 37 stacked sequentially in a longitudinal direction. The light emitting element 30 may further include an insulating film 38 covering outer surfaces (e.g., the outer peripheral surfaces) of the first semiconductor layer 31, the second semiconductor layer 32, the active layer 33. Further, as shown in FIG. 4, the insulating film 38 may also cover the electrode layer 37.

The first semiconductor layer 31 may be, for example, an n-type semiconductor having a first conductivity type. The first semiconductor layer 31 may be doped with a first conductivity type dopant, and the first conductivity type dopant may be, for example, Si, Ge, or Sn. In an embodiment, the first semiconductor layer 31 may be n-GaN doped with n-type Si.

The second semiconductor layer 32 may be spaced from the first semiconductor layer 31. The second semiconductor layer 32 may be, for example, a p-type semiconductor having a second conductivity type. The second semiconductor layer 32 may be doped with a second conductivity type dopant, and the second conductivity type dopant may be, for example, Mg, Zn, Ca, Se, or Ba. In an embodiment, the second semiconductor layer 32 may be p-GaN doped with p-type Mg.

The active layer 33 may be disposed between the first semiconductor layer 31 and the second semiconductor layer 32. The active layer 33 may include a material having a single or multiple quantum well structure. The active layer 33 may emit light through combination of electron-hole pairs according to electrical signals received through the first semiconductor layer 31 and the second semiconductor layer 32. However, the present disclosure is not limited thereto, and the active layer 33 may also have a structure in which a semiconductor material having a large band gap energy and a semiconductor material having a small band gap energy are alternately stacked or may include different Group III-Group V semiconductor materials depending on the wavelength band of light that it emits.

Light emitted from the active layer 33 may be radiated not only to the outer surface of the light emitting element 30 in the longitudinal direction but also to both side surfaces. The direction of light emitted from the active layer 33 is not limited to one direction.

The electrode layer 37 may be disposed on the second semiconductor layer 32. The electrode layer 37 may be an ohmic contact electrode. However, the present disclosure is not limited thereto, and the electrode layer 37 may also be a Schottky contact electrode. In some embodiments, an additional electrode layer may also be located on the first semiconductor layer 31.

When the light emitting element 30 is electrically connected to an electrode (e.g., the first and second electrodes 21 and 22) or a contact electrode (e.g., the first and second contact electrodes 26 and 27) in the display device 10, the electrode layer 37 may reduce the resistance between the light emitting element 30 and the electrode or the contact electrode. The electrode layer 37 may include a conductive metal. For example, the electrode layer 37 may include at least any one of aluminum (Al), titanium (Ti), indium (In), gold (Au), silver (Ag), indium tin oxide (ITO), indium zinc oxide (IZO), and indium tin zinc oxide (ITZO). In some embodiments, the electrode layer 37 may include an n-type or p-type doped semiconductor material.

The insulating film 38 surrounds the outer surfaces (e.g., the outer peripheral surfaces) of the semiconductor layers 31 and 32, the active layer 33, and the electrode layer 37 described above. In an embodiment, the insulating film 38 may surround the outer surface (e.g., the outer peripheral surface) of at least the active layer 33 and extend in the direction in which the light emitting element 30 extends. The insulating film 38 may protect the above members (e.g., the semiconductor layers 31 and 32, the active layer 33, and the electrode layer 37) of the light emitting element 30. For example, the insulating film 38 may surround side surfaces of the above members but may expose both ends of the light emitting element 30 in the longitudinal direction. For example, the insulating film 38 may expose an outer surface of the electrode layer 37 of the light emitting element 30. The insulating film 38 may include a material having insulating properties. Accordingly, the insulating film 38 can prevent an electrical short circuit that may occur when the active layer 33 directly contacts an electrode that transmits an electrical signal to the light emitting element 30. In some embodiments, because the insulating film 38 protects the outer surface of the light emitting element 30 including the active layer 33, a reduction in luminous efficiency can be prevented (or reduced).

In some embodiments, an outer surface of the insulating film 38 may be treated. During the manufacturing of the display device 10, a plurality of light emitting elements 30 may be sprayed onto electrodes in a state where they are dispersed in an ink (e.g., a set or predetermined ink) and then may be aligned. Here, the surface of the insulating film 38 may be hydrophobically or hydrophilically treated so that each light emitting element 30 remains separate from other adjacent light emitting elements 30 in the ink without being agglomerated with them.

During the manufacturing of the display device 10, the light emitting elements 30 dispersed in an ink (e.g., a set or predetermined ink) may be sprayed and aligned on the first substrate 11 on which the first and second electrodes 21 and 22 and the second bank 60 are formed. For example, the light emitting elements 30 may be placed between the first electrode 21 and the second electrode 22 in an area defined by the second bank 60 through a printing process of spraying (or jetting) ink including the light emitting elements 30 by using the inkjet printing device 1000 (see FIG. 5).

An inkjet printing device 1000 in which a printing process of aligning the light emitting elements 30 is performed during the process of manufacturing the display device 10 will now be described. The display device 10 described above is an example device manufactured using the inkjet printing device 1000, and a device manufactured using the inkjet printing device 1000 is not limited to the display device 10 described above.

An inkjet printing device according to an embodiment will now be described.

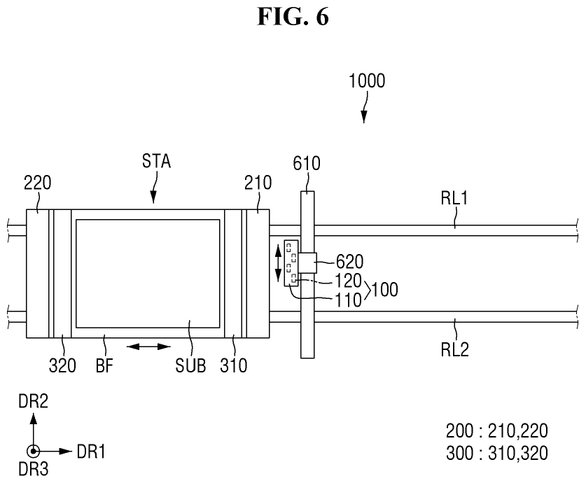

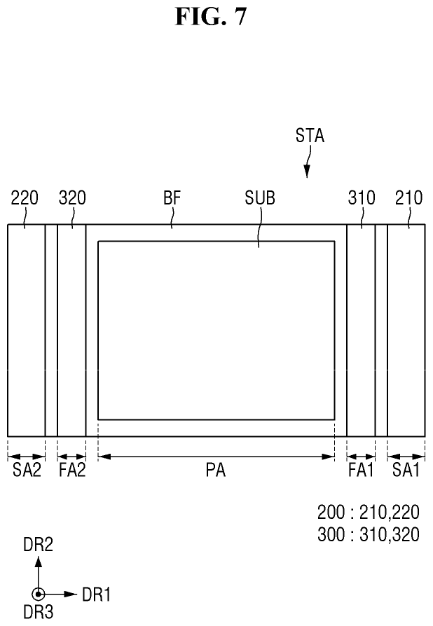

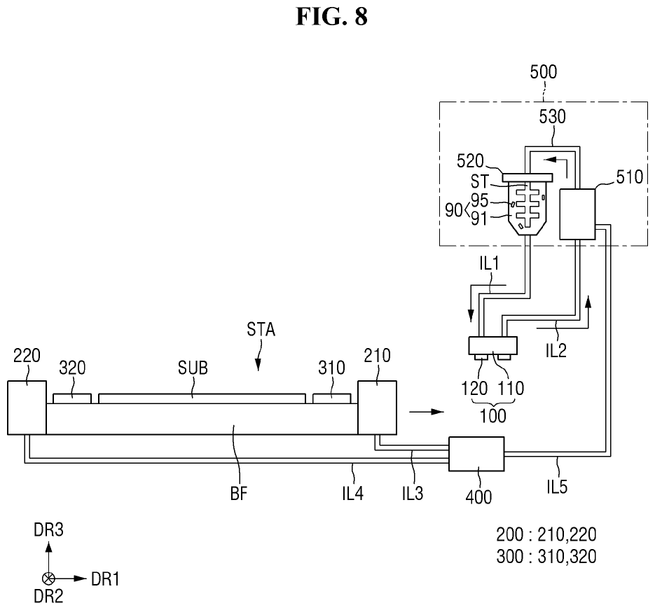

FIG. 5 is a schematic perspective view of an inkjet printing device 1000 according to an embodiment. FIG. 6 is a partial plan view of the inkjet printing device 1000 of FIG. 5. FIG. 7 is a plan view of a stage unit STA according to an embodiment. FIG. 8 is a schematic view of a stage unit STA, an ink collecting part 400, and an ink providing part 500 according to an embodiment.

Referring to FIGS. 5 and 6, the inkjet printing device 1000 according to the embodiment may include the stage unit STA including a stage BF, suction devices 200 (e.g., 210, 220) and preliminary jetting parts 300 (e.g., 310, 320) and a print head unit 100. The inkjet printing device 1000 may further include a first moving unit including first and second rails RL1 and RL2 for moving the stage unit STA, the ink collecting part 400, and the ink providing part 500.

In the drawings for describing the inkjet printing device 1000, a first direction DR1, a second direction DR2, and a third direction DR3 are defined. The first direction DR1 and the second direction DR2 may be directions perpendicular to each other in one plane. The third direction DR3 may be a direction perpendicular to the plane in which a first imaginary line extending in the first direction DR1 and a second imaginary line extending in the second direction DR2 are located. In some embodiments of the inkjet printing device 1000 and a printing method using the inkjet printing device 1000, unless otherwise mentioned, “above” indicates the third direction DR3, and an “upper surface” indicates a surface facing the third direction DR3. In addition, “below” indicates a direction opposite to the third direction DR3, and a “lower surface” indicates a surface facing the direction opposite to the third direction DR3. In some embodiments, “left,” “right,” “upper,” and “lower” indicate directions when the inkjet printing device 1000 is seen in a plan view. For example, “right” indicates a direction of the first direction DR1, “left” indicates a direction opposite to the first direction DR1, “upper” indicates a direction of the second direction DR2, and “lower” indicates a direction opposite to the second direction DR2.

The stage unit STA provides a space in which a target substrate SUB is disposed. The target substrate SUB may be disposed on the stage unit STA while a printing process is performed.

The overall planar shape of the stage unit STA may follow the planar shape of the target substrate SUB. For example, when the target substrate SUB has a rectangular shape, the overall shape of the stage unit STA may be a rectangular shape. In the drawings, the rectangular stage unit STA having long sides disposed in the first direction DR1 and short sides disposed in the second direction DR2 is illustrated.

The first moving unit may adjust relative positions of the stage unit STA and the print head unit 100. The first moving unit may include the first and second rails RL1 and RL2.

The stage unit STA may be disposed on the first and second rails RL1 and RL2 extending in the first direction DR1. While the stage unit STA disposed on the first and second rails RL1 and RL2 reciprocates along the first direction DR1 and an opposite direction, a printing process may be performed on the entire area of the target substrate SUB.

The structure of the stage unit STA will be described in detail later with reference to other drawings.

The target substrate SUB described herein is an object to be processed by the inkjet printing device 1000 according to the embodiment and may be any type of substrate (e.g., a substrate of any type of display device) such as an inorganic light emitting display device including inorganic LEDs including inorganic semiconductors, an organic light emitting display device including organic LEDs (OLEDs) including organic light emitting layers, a micro-LED display device including micro-LEDs, or a quantum dot light emitting display device using quantum dot LEDs including quantum dot light emitting layers. The target substrate SUB will be described below as an inorganic light emitting display substrate including the inorganic LEDs described above with reference to FIGS. 1-4. However, the present disclosure is not limited thereto, and the target substrate SUB can also be applied to other display devices as long as the same technical spirit is applicable.

Referring to FIGS. 5-8, the print head unit 100 may serve to print ink 90 on the target substrate SUB. The print head unit 100 may spray an ink 90 (e.g., a set or predetermined ink 90 (e.g., see, FIG. 8)) onto the target substrate SUB when the inkjet printing device 1000 is driven. The print head unit 100 may spray the ink 90 supplied from the ink providing part 500 (e.g., see, FIG. 8) which will be described later onto the target substrate SUB provided on the stage unit STA.

The ink 90 sprayed from the print head unit 100 may be in a solution state or a colloid state. The ink 90 may include a solvent 91 and a plurality of particles 95 dispersed in the solvent 91. For example, the solvent 91 may include acetone, water, alcohol, toluene, propylene glycol (PG), triethylene glycol monobutyl ether (TGBE), diethylene glycol monophenyl ether (DGPE), amide compounds, diethylene glycol dibenzonate, triethyl citrate, benzyl butyl phthalate, bis(2-ethylhexyl) phthalate, bis(2-ethylhexyl) isophthalate, ethyl phthalyl ethyl glycolate), or propylene glycol methyl acetate (PGMA). The particles 95 dispersed in the solvent 91 may be supplied to the ink providing part 500 and sprayed through the print head unit 100. The particles 95 may be, but are not limited to, inorganic LEDs made of an inorganic material described above with reference to FIG. 4.

The print head unit 100 is disposed above the stage unit STA. The print head unit 100 may be mounted on a second moving unit 620 disposed on a first support 610. The manner in which the print head unit 100 is mounted on the second moving unit 620 is not particularly limited. For example, the print head unit 100 may be directly disposed on the second moving unit 620 or may be mounted or coupled onto the second moving unit 620 through a separate coupling member.

The first support 610 may include a first horizontal support part 611 extending in the second direction DR2 which is a horizontal direction and first vertical support parts 612 connected to the first horizontal support part 611 and extending in the third direction DR3 which is a vertical direction. The direction in which the first horizontal support part 611 extends may be the same as the second direction DR2 perpendicular to the first direction DR1 in which the stage unit STA moves on the first and second rails RL1 and RL2 in a plan view. The print head unit 100 may be mounted on the second moving unit 620 disposed on the first horizontal support part 611.

The second moving unit 620 may move along a direction on the first horizontal support part 611. The second moving unit 620 may move along the second direction DR2 on the first horizontal support part 611, and the print head unit 100 may be fixed to the second moving unit 620 to move along the second direction DR2 together with the second moving unit 620. The stage unit STA may reciprocate in the first direction DR1 through the first and second rails RL1 and RL2, and the print head unit 100 may reciprocate in the second direction DR2 through the second moving unit 620. In so doing, the ink 90 may be sprayed to the entire area of the target substrate SUB even with the print head unit 100 whose area is smaller than that of the target substrate SUB.

Although the stage unit STA moves along the first direction DR1 on the first and second rails RL1 and RL2 and the print head unit 100 moves along the second direction DR2 in the drawings, the present disclosure is not limited thereto. For example, an inkjet printing device according to some embodiments may further include a horizontal moving unit which moves the print head unit 100 in the first direction DR1. In this case, the first and second rails RL1 and RL2 which move the stage unit STA in the first direction DR1 may be omitted. That is, the stage unit STA may be fixed, and the print head unit 100 may perform a printing process on the entire area of the target substrate SUB while reciprocating along the first direction DR1 and the second direction DR2 above the stage unit STA. That is, the relative positions of the stage unit STA and the print head unit 100 may be adjusted as the print head unit 100 moves along the first and second directions DR1 and DR2 which are horizontal directions while the stage unit STA is fixed or may be adjusted as the stage unit STA moves along the first and second directions DR1 and DR2 which are horizontal directions while the print head unit 100 is fixed.

A case where the stage unit STA reciprocates along the first direction DR1 using the first moving unit including the first and second rails RL1 and RL2 and where the print head unit 100 reciprocates along the second direction DR2 using the second moving unit 620 is illustrated in the drawings and will be described below as an example. However, a method of adjusting the relative positions of the stage unit STA and the print head unit 100 is not limited thereto.

The print head unit 100 may be mounted on the second moving unit 620 disposed on the first support 610 and spaced from the stage unit STA by a distance (e.g., a set or predetermined distance) in the third direction DR3. The distance between the print head unit 100 and the stage unit STA in the third direction DR3 may be adjusted by a height of each first vertical support part 612 of the first support 610. The distance between the print head unit 100 and the stage unit STA may be adjusted within the range that can secure a space required for a printing process by allowing the print head unit 100 to be spaced from the target substrate SUB by a certain distance when the target substrate SUB is placed on the stage unit STA.

The print head unit 100 may include a first base part 110 and a plurality of inkjet heads 120 located on a lower surface of the first base part 110 (see, FIG. 6).

The first base part 110 may extend along a direction. For example, the direction in which the first base part 110 extends may be the same as the direction in which the first horizontal support part 611 extends. As illustrated in the drawings, the first base part 110 may include long sides extending in the second direction DR2 and short sides extending in the first direction DR1. However, the shape of the first base part 110 is not limited thereto.

The inkjet heads 120 may be disposed on a surface, e.g., the lower surface of the first base part 110. The inkjet heads 120 may be spaced from each other. The inkjet heads 120 may be disposed in a direction and arranged in one row or a plurality of rows.

Although the inkjet heads 120 are arranged in two rows and the inkjet heads 120 of each row are staggered with those of the other row, the present disclosure is not limited thereto. For example, the inkjet heads 120 may also be arranged in a larger number of rows, and the inkjet heads 120 disposed in each row may overlap those of adjacent rows without being staggered with them. In some embodiments, although the print head unit 100 includes four inkjet heads 120 (e.g., as shown in the drawings (e.g., FIG. 6), the number of inkjet heads 120 is not limited thereto. In an embodiment, the number of inkjet heads 120 disposed in one print head unit 100 may be, but is not limited to, 128 to 1800. The planar shape of each inkjet head 120 is not particularly limited but may be, for example, a quadrangular shape.

The stage unit STA according to an embodiment may include a substrate mounting part PA, suction areas SA1 and SA2, and preliminary jetting areas FA1 and FA2 (see, FIG. 7).

The substrate mounting part PA may be an area where the target substrate SUB is mounted. The target substrate SUB may be mounted in the substrate mounting part PA, and a process of spraying the ink 90 onto the target substrate SUB may be performed. That is, the substrate mounting part PA may be an area where the target substrate SUB is disposed and a printing process of spraying the ink 90 onto the target substrate SUB is performed. The substrate mounting part PA may be located in the center of the stage unit STA.

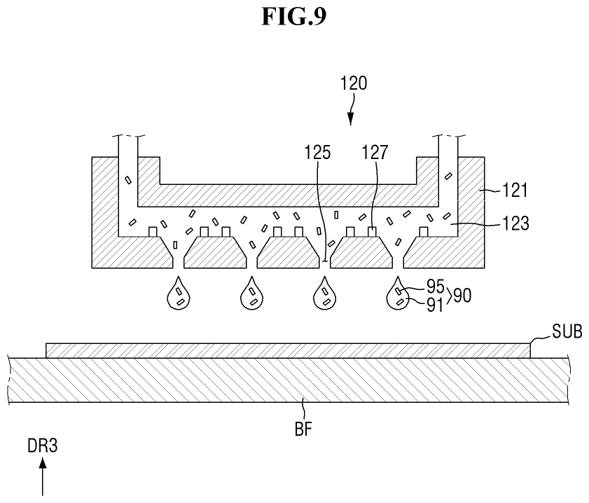

The suction areas SA1 and SA2 may be areas for generating negative pressure on the inkjet heads 120 to remove particles remaining in nozzles 125 (see FIG. 9) of the inkjet heads 120, which will be described later, before a printing process of spraying the ink 90 onto the target substrate SUB is performed. The suction areas SA1 and SA2 may be disposed on sides of the substrate mounting part PA. The suction areas SA1 and SA2 may be areas where a process of removing particles remaining in the nozzles 125 of the inkjet heads 120 is performed before a printing process is performed.

In an embodiment in which the stage unit STA reciprocates along the first direction DR1 while a printing process is performed, the suction areas SA1 and SA2 may be disposed on a side and/or the other side of the substrate mounting part PA in the first direction DR1 and spaced from the substrate mounting part PA.

The suction areas SA1 and SA2 may include a first suction area SA1 and a second suction area SA2. The first suction area SA1 and the second suction area SA2 may be disposed on a side and the other side of the substrate mounting part PA in the first direction DR1, respectively. For example, the first suction area SA1 may be disposed on a right side of the substrate mounting part PA in a plan view, and the second suction area SA2 may be disposed on a left side of the substrate mounting part PA in a plan view. Although the suction areas SA1 and SA2 are disposed on both sides of the substrate mounting part PA in the drawings, the present disclosure is not limited thereto. For example, a suction area may be disposed on only one of both sides of the substrate mounting part PA.

The preliminary jetting areas FA1 and FA2 may be areas to which the ink 90 is pre-jetted (or temporarily jetted) from the inkjet heads 120 a number of times (e.g., a set or predetermined number of times) before a printing process of spraying the ink 90 onto the target substrate SUB is performed. That is, the preliminary jetting areas FA1 and FA2 may be areas to which the ink 90 is jetted from the inkjet heads 120 a plurality of times so that the number of particles included in the ink 90 jetted from the inkjet heads 120 is maintained uniformly or substantially uniformly. The preliminary jetting areas FA1 and FA2 may be spaced from the substrate mounting part PA.

The preliminary jetting areas FA1 and FA2 may be disposed between the substrate mounting part PA and the suction areas SA1 and SA2. The preliminary jetting areas FA1 and FA2 may include a first preliminary jetting area FA1 and a second preliminary jetting area FA2. The first preliminary jetting area FA1 may be disposed between the substrate mounting part PA and the first suction area SA1, and the second preliminary jetting area FA2 may be disposed between the substrate mounting part PA and the second suction area SA2.

In an embodiment in which the stage unit STA reciprocates along the first direction DR1 while a printing process is performed, the first preliminary jetting area FA1 may be disposed between the substrate mounting part PA and the first suction area SA1, that is, on the right side of the substrate mounting part PA and a left side of the first suction area SA1. Likewise, the second preliminary jetting area FA2 may be disposed between the substrate mounting part PA and the second suction area SA2, that is, on the left side of the substrate mounting part PA and a right side of the second suction area SA2.

As described above, the stage unit STA may include the stage BF, the suction devices 200, and the preliminary jetting parts 300.

The stage BF may be disposed in the substrate mounting part PA and the preliminary jetting areas FA1 and FA2. The stage BF may provide a space in which the target substrate SUB is disposed in the substrate mounting part PA. In some embodiments, the stage BF may support the preliminary jetting parts 300 in the preliminary jetting areas FA1 and FA2.

The overall planar shape of the stage BF may follow the planar shape of the target substrate SUB. For example, when the target substrate SUB has a rectangular shape in a plan view, the planar shape of the stage BF may be a rectangular shape as illustrated in the drawings. At least one aligner may also be disposed on the stage BF to align the target substrate SUB.

The suction devices 200 may be disposed in the suction areas SA1 and SA2. The suction devices 200 may be disposed on a side and the other side of the stage BF in the first direction DR1. Although the suction devices 200 are integrally disposed on both sides (e.g., a side and the other side in the first direction DR1) of the stage BF in the drawings, the present disclosure is not limited thereto. For example, the suction devices 200 may also be disposed on both sides of the stage BF at a distance from the stage BF.

The suction devices 200 may form negative pressure on the suction devices 200. For example, the suction devices 200 may be driven to form (or generate) negative pressure between the suction devices 200 and the inkjet heads 120 when the inkjet heads 120 are positioned above the suction devices 200. When the inkjet heads 120 are placed above the suction devices 200, the suction devices 200 may form negative pressure between the inkjet heads 120 and the suction devices 200 and remove particles remaining in the nozzles 125 of the inkjet heads 120 using a suction force caused by the negative pressure.

The suction devices 200 may include a first suction device 210 and a second suction device 220. The first suction device 210 may be disposed in the first suction area SA1, and the second suction device 220 may be disposed in the second suction area SA2.

The preliminary jetting parts 300 may be disposed on the stage BF in the preliminary jetting areas FA1 and FA2. The preliminary jetting parts 300 may provide areas to which the ink 90 is pre-jetted using the inkjet heads 120 and may absorb the jetted ink 90. The inkjet heads 120 may jet the ink 90 onto the preliminary jetting parts 300 a number of times (e.g., a set or predetermined number of times) so that the number of particles included in the ink 90 jetted from the inkjet heads 120 in the preliminary jetting areas FA1 and FA2 becomes uniform, and the preliminary jetting parts 300 may absorb the jetted ink 90. Each of the preliminary jetting parts 300 may include a member that absorbs the ink 90. For example, each of the preliminary jetting parts 300 may include an absorption pad.

The preliminary jetting parts 300 may include a first preliminary jetting part 310 and a second preliminary jetting part 320. The first preliminary jetting part 310 may be disposed in the first preliminary jetting area FA1, and the second preliminary jetting part 320 may be disposed in the second preliminary jetting area FA2.

The ink collecting part 400 may temporarily store or accommodate the ink 90 sucked from the suction devices 200 and send the ink 90 to the ink providing part 500. That is, the ink collecting part 400 may be connected to the first suction device 210 through a third connection tube IL3 and connected to the second suction device 220 through a fourth connection tube IL4 to collect the ink 90 sucked from the first and second suction devices 210 and 220. In some embodiments, the ink collecting part 400 may be connected to the ink providing part 500 through a fifth connection tube IL5 to provide the ink 90 collected from the first and second suction devices 210 and 220 to the ink providing part 500. The ink collecting part 400 may collect the ink 90 sucked from each of the first and second suction devices 210 and 220 and send the ink 90 to the ink providing part 500, thereby reusing (or recycling) the ink 90.

The shape and structure of the ink collecting part 400 are not particularly limited as long as the ink collecting part 400 can store or accommodate the ink 90 collected from the first and second suction devices 210 and 220. For example, the ink collecting part 400 may have a shape that forms a space (e.g., a set or predetermined space) for storing or accommodating the ink 90, for example, may have a cuboid, cylindrical, or spherical shape.

The ink providing part 500 may be connected to the print head unit 100 through first and second connection tubes IL1 and IL2 to provide the ink 90 to the print head unit 100. In some embodiments, the ink providing part 500 may be connected to the ink collecting part 400 through the fifth connection tube IL5 to receive the ink 90 stored or accommodated in the ink collecting part 400 and may provide the ink 90 to the print head unit 100.

The ink providing part 500 according to an embodiment may include an ink storage part 510 and an ink stirrer 520 (see, FIG. 8). The ink providing part 500 may further include a sixth connection tube 530 connecting the ink storage part 510 and the ink stirrer 520. The ink storage part 510 may be connected to the print head unit 100 through the second connection tube IL2, the ink stirrer 520 may be connected to the print head unit 100 through the first connection tube IL1, and the ink storage part 510 and the ink stirrer 520 may be connected through the sixth connection tube 530. Thus, they may form one ink circulation system.

The ink storage part 510 may store the manufactured ink 90 and supply the ink 90 to the ink stirrer 520. In some embodiments, the ink storage part 510 may be connected to the ink collecting part 400 through the fifth connection tube IL5 to receive the ink 90 collected from the first and second suction devices 210 and 220 by the ink collecting part 400. In some embodiments, the ink storage part 510 may be connected to the print head unit 100 through the second connection tube IL2 to collect and store the ink 90 not sprayed through the inkjet heads 120 of the print head unit 100.

The shape of the ink storage part 510 is not particularly limited. In an embodiment, the ink storage part 510 may be an ink cartridge or an ink vessel. In some embodiments, the ink storage part 510 may further include a pneumatic forming device capable of forming pressure for supplying the ink 90 to the ink stirrer 520.

The ink stirrer 520 according to an embodiment may include a stirring device ST. The ink stirrer 520 may stir the ink 90 supplied from the ink storage part 510 and disperse the particles 95 using the stirring device ST and send the ink 90 having a uniform degree of dispersion to the print head unit 100. The particles 95 dispersed in the solvent 91 include a material having a relatively large specific gravity. Thus, the particles 95 may settle or sink in the manufactured ink 90 over time. Therefore, by dispersing the particles 95 using the stirring device ST, it is possible to prevent the number of particles 95 in the ink 90 jetted through the inkjet heads 120 from varying depending on a process time due to the sinking of the particles 95 to the bottom of the ink stirrer 520. The type of the stirring device ST is not particularly limited. For example, the stirring device ST may include a magnetic stirrer or a propeller stirrer.

FIG. 9 is a schematic cross-sectional view of an inkjet head 120 according to an embodiment.

Referring to FIG. 9, the inkjet head 120 may include a head base 121 and a first internal tube 123 and a plurality of nozzles 125 inside the head base 121. The inkjet head 120 may further include piezoelectric elements 127.

The inkjet head 120 including the nozzles 125 may jet the ink 90 through the nozzles 125. The ink 90 jetted from the nozzles 125 may be sprayed onto the target substrate SUB provided on the stage BF and/or the first and second preliminary jetting parts 310 and 320 disposed on the stage BF.

The head base 121 may be a part that forms the body of the inkjet head 120. The head base 121 may extend along a direction. The direction in which the head base 121 extends may be the same as the direction in which the first horizontal support part 611 of the first support 610 extends. That is, the direction in which the head base 121 extends may be the second direction DR2 perpendicular to the first direction DR1 in which the stage unit STA moves.

The first internal tube 123 may be formed along the extending direction of the head base 121. The first internal tube 123 may be connected to an internal flow path of the print head unit 100 to receive the ink 90 from the first base part 110. The ink 90 supplied through the first base part 110 may flow in along the first internal tube 123 and jetted through the nozzles 125 of the inkjet head 120.

Each nozzle 125 may be connected to the first internal tube 123 of the inkjet head 120. The ink 90 supplied to the first internal tube 123 may flow along the first internal tube 123 and may be sprayed through each nozzle 125. The ink 90 sprayed through the nozzles 125 may be supplied to an upper surface of the target substrate SUB. The amount of ink 90 jetted through the nozzles 125 may be adjusted according to a voltage applied to the piezoelectric elements 127 disposed in the individual nozzles 125. As the pressure generated according to the voltage applied to the piezoelectric elements 127 disposed in the individual nozzles 125 is applied to the ink 90 around the nozzles 125, the ink 90 may be sprayed through the nozzles 125. For example, in a non-spray mode, the piezoelectric elements 127 of the inkjet head 120 are adjusted so that internal pressure and external pressure of the inkjet head 120 are substantially in equilibrium. Accordingly, the ink 90 may not be sprayed through the nozzles 125. In a spray mode, the piezoelectric elements 127 of the inkjet head 120 are adjusted so that the internal pressure of the inkjet head 120 is greater than the external pressure. Accordingly, the ink 90 may be sprayed through the nozzles 125.

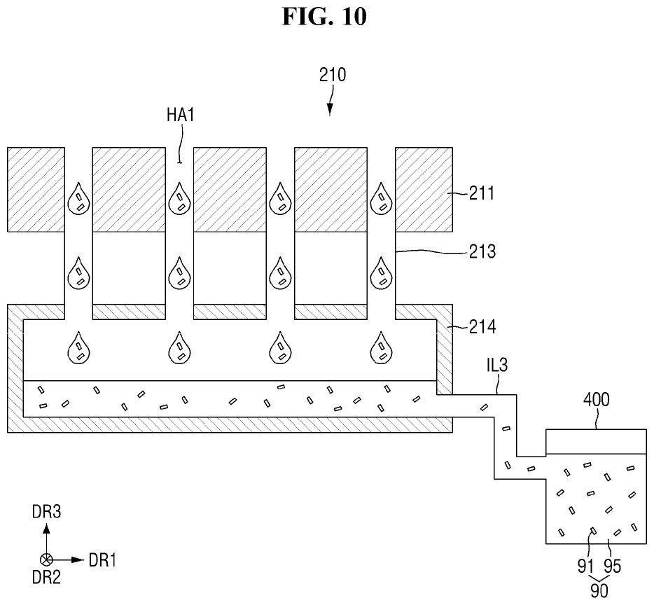

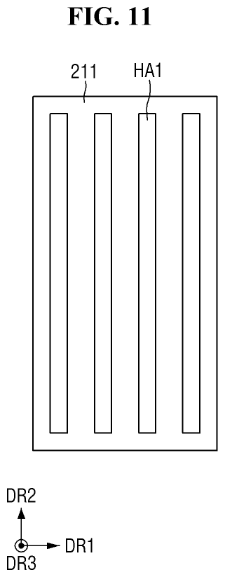

FIG. 10 is a schematic cross-sectional view of a first suction device 210 and an ink collecting part 400 according to an embodiment. FIG. 11 is a plan view of an example of a suction body 211 of the first suction device 210.

The structure of the first suction device 210 and the connection relationship between the first suction device 210 and the ink collecting part 400 will now be described. The structure of the first suction device 210 and the connection relationship between the first suction device 210 and the ink collecting part 400 may be the same or similar to the second suction device 220. Therefore, a description of the structure of the second suction device 220 and the connection relationship between the second suction device 220 and the ink collecting part 400 will not be repeated.

Referring to FIGS. 10 and 11, the first suction device 210 may remove the particles 95 remaining in the nozzles 125 of the inkjet heads 120 by forming negative pressure on the first suction device 210. For example, the first suction device 210 may include an air suction device such as a vacuum pump.

The first suction device 210 may include the suction body 211, a suction storage part 214, second internal tubes 213 connecting a plurality of suction holes HA1 and the suction storage part 214, and a vacuum suction pump. The first suction device 210 may remove the particles 95 remaining in the nozzles 125 of the inkjet heads 120 by generating negative pressure on the first suction device 210.

The suction body 211 may be structured to include a plurality of openings so that negative pressure can be generated. For example, the suction body 211 may be structured to include a plurality of holes or a plurality of pores penetrating the suction body 211. In an embodiment, the suction body 211 may include the suction holes HA1 penetrating the suction body 211.

The suction holes HA1 may be spaced from each other. Each suction hole HA1 may have various sizes and cross-sectional shapes as long as the particles 95 in the ink 90 can pass through the suction hole HA1. In an embodiment, the suction holes HA1 formed in the suction body 211 may extend along the second direction DR2. The suction holes HA1 extending along the second direction DR2 may be spaced from each other in the first direction DR1. Although four suction holes HA1 are formed in one suction body 211 in the drawings, the number of suction holes HA1 is not limited thereto.

The ink 90 including the particles 95 sucked through the suction holes HA1 may move to the suction storage part 214 through the second internal tubes 213. The suction storage part 214 may temporarily store or accommodate the ink 90 sucked by the first suction device 210 and send the ink 90 to the ink collecting part 400 through the third connection tube IL3.

In some embodiments, the suction storage part 214 may be omitted. When the suction storage part 214 is omitted, the suction body 211 of the first suction device 210 may be directly connected to the ink collecting part 400 through the third connection tube IL3, and the ink 90 sucked through the suction body 211 may be directly provided to the ink collecting part 400 through the third connection tube IL3.

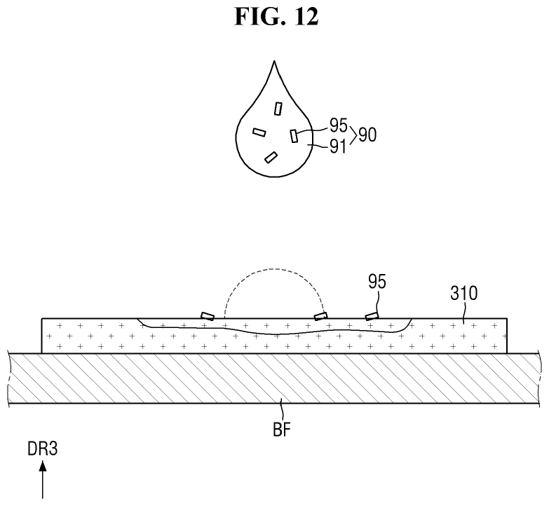

FIG. 12 is a schematic cross-sectional view of a first preliminary jetting part 310 according to an embodiment.

The first preliminary jetting part 310 will now be described. The description of the first preliminary jetting part 310 may also be applied to the second preliminary jetting part 320 which may be the same as or similar to the first preliminary jetting part 310. Therefore, a description of the second preliminary jetting part 320 will not be repeated.

Referring to FIG. 12, the first preliminary jetting part 310 may provide an area to which the ink 90 is pre-jetted using the inkjet heads 120 and may absorb the ink 90 jetted to the first preliminary jetting part 310. The first preliminary jetting part 310 may include an absorption pad. For example, the first preliminary jetting part 310 may include a porous pad or a sponge made of a porous material. Because the first preliminary jetting part 310 includes a member that absorbs the ink 90, the ink 90 can be repeatedly jetted onto the first preliminary jetting part 310 a number of times (e.g., a set or predetermined number of times).

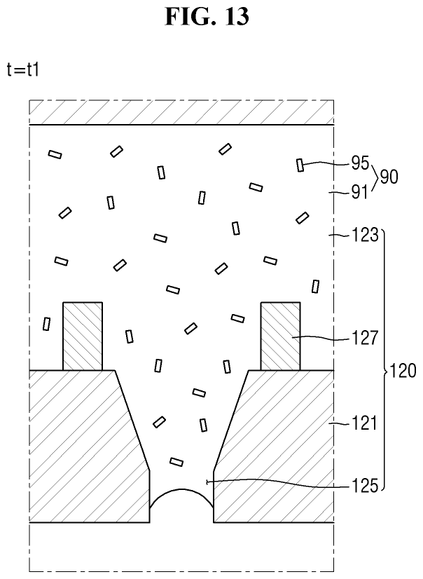

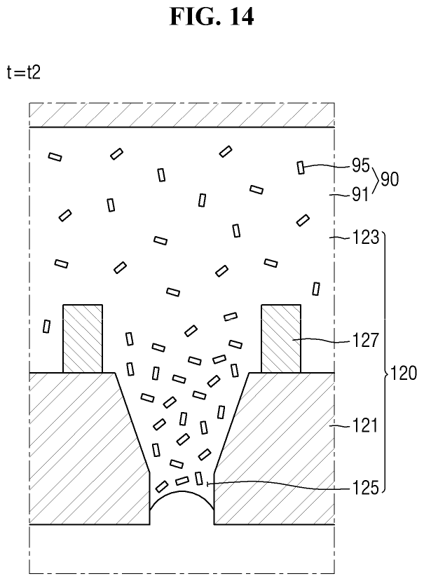

FIG. 13 is a partial cross-sectional view of an inkjet head 120 at a first printing standby time. FIG. 14 is a partial cross-sectional view of the inkjet head 120 at a second printing standby time.

FIGS. 13 and 14 illustrate dispersion states of the particles 95 in an area around a nozzle 125 in a printing standby state in which the ink 90 is not sprayed. FIG. 13 may be a state in which the particles 95 are dispersed in the area around the nozzle 125 at a first time (t=t1) in the printing standby state, and FIG. 14 may be a state in which the particles 95 are dispersed in the area around the nozzle 125 at a second time (t=t2) different from the first time (t=t1) in the printing standby state. The first time (t=t1) may be an initial time in the printing standby state, and the second time (t=t2) may be a time (e.g., a set or predetermined period of time) after the initial time in the printing standby state.

As used herein, the term “printing standby state” may refer to a state other than a state in which a printing process of spraying the ink 90 onto the target substrate

SUB through the nozzle 125 of the inkjet head 120 is performed. For example, setting the inkjet printing device 1000 before a printing process is performed or moving the inkjet head 120 to adjust the position of the inkjet head 120 during the printing process while the ink 90 is not sprayed onto the target substrate SUB may be included in the “printing standby state.” That is, the “printing standby state” may include the non-spray mode in which the ink 90 is not sprayed through the nozzle 125 of the inkjet had 120.

As described above, spraying (or jetting) of the ink 90 through the nozzle 125 may be performed using the piezoelectric elements 127. In the printing standby state (or the non-spray mode), the piezoelectric elements 127 may be adjusted so that the pressure inside the inkjet head 120 and the pressure outside the inkjet head 120 reach an equilibrium. For example, in the printing standby state, the piezoelectric elements 127 may be adjusted so that hydraulic pressure of the ink 90 located in the first internal tube 123 and the nozzle 125 of the inkjet head 120 reaches an equilibrium or substantial equilibrium with atmospheric pressure outside the inkjet head 120.

Therefore, during the printing standby state, the ink 90 may not be sprayed through the nozzle 125 of the inkjet head 120.

During the printing standby state, the degree of dispersion of the particles 95 in the ink 90 remaining in the inkjet head 120 may change over time. For example, the particles 95 dispersed in the ink 90 may maintain the initial dispersion state in the nozzle 125 of the inkjet head 120 and/or in the area around the nozzle 125 but may settle over time.

Referring to FIG. 13, at the first time (t=t1) which is an initial time in the printing standby state, the particles 95 in the ink 90 remaining in the inkjet head 120 may be uniformly or substantially uniformly dispersed in the solvent 91. That is, the particles 95 remaining in the first internal tube 123 and the nozzle 125 of the inkjet head 120 may be uniformly or substantially uniformly dispersed in the solvent 91. Thus, the degree of dispersion of the particles 95 may be uniform or substantially uniform in the nozzle 125 and in the area around the nozzle 125.

Referring to FIG. 14, at the second time (t=t2) after a period of time (e.g., a set or predetermined period of time) in the printing standby state, gravity may act on the ink 90 remaining in the inkjet head 120 in a direction opposite to the third direction DR3. Therefore, the particles 95 having a greater specific gravity than the solvent 91 included in the ink 90 remaining in the inkjet head 120 may settle to the bottom of the inkjet head 120. That is, the particles 95 remaining in the first internal tube 123 and the nozzle 125 of the inkjet head 120 may settle to the bottom of the inkjet head 120, for example, to the area around the nozzle 125. Accordingly, because the particles 95 remaining in the inkjet head 120 are concentrated in the area around the nozzle 125 at the second time (t=t2) in the printing standby state, the degree of dispersion of the particles 95 in the area around the nozzle 125 may be non-uniform. When the particles 95 settle and agglomerate with each other in the nozzle 125 and in the area around the nozzle 125, the nozzle 125 may be clogged with the particles 95 concentrated in the nozzle 125 at the initial time of a printing process performed immediately after the printing standby state, or an over-jetting phenomenon in which the number of particles 95 included in the jetted ink 90 is excessively large may occur. Therefore, the number of particles 95 jetted from the inkjet head 120 may greatly vary depending on a point in time in the printing process performed after the printing standby state.

The inkjet printing device 1000 according to the embodiment includes the suction devices 200 which remove the particles 95 remaining in the area around the nozzle 125 of the inkjet head 120 before the printing process of spraying the ink 90 onto the target substrate SUB is performed (or in the printing standby state) and the preliminary jetting parts 300 to which the ink 90 is pre-jetted (or pre-ejected). Therefore, the nozzle 125 of the inkjet head 120 can spray a substantially constant amount of ink 90 and maintain substantially the same number of particles 95 in the ink 90 while performing the printing process on the target substrate SUB after the standby state. The suction devices 200 may suck the particles 95 that have settled in the area around the nozzle 125 of the inkjet head 120 by generating negative pressure. In some embodiments, the ink 90 may be pre-jetted to the preliminary jetting parts 300 a plurality of times before the printing process is performed, so that the number of particles 95 included in the jetted ink 90 is maintained uniformly or substantially uniformly. Therefore, because the number of particles 95 included in the ink 90 jetted while the printing process of spraying the ink 90 onto the target substrate SUB is performed is maintained uniformly or substantially uniformly, the reliability of the printing process using the inkjet printing device 1000 may be improved, and the quality of the display device 10 may be enhanced.

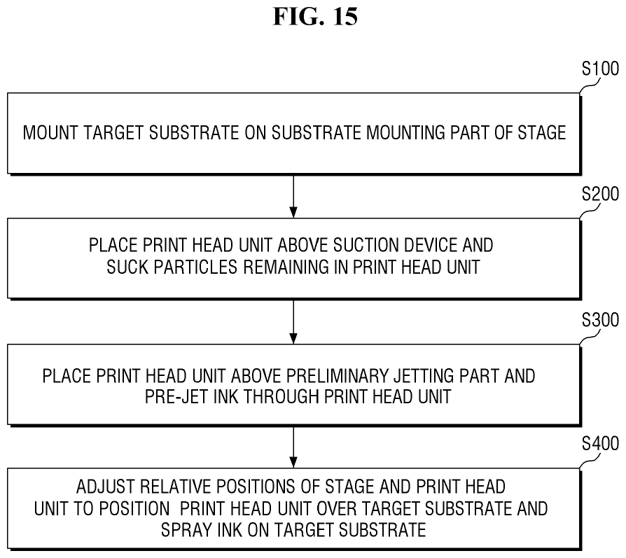

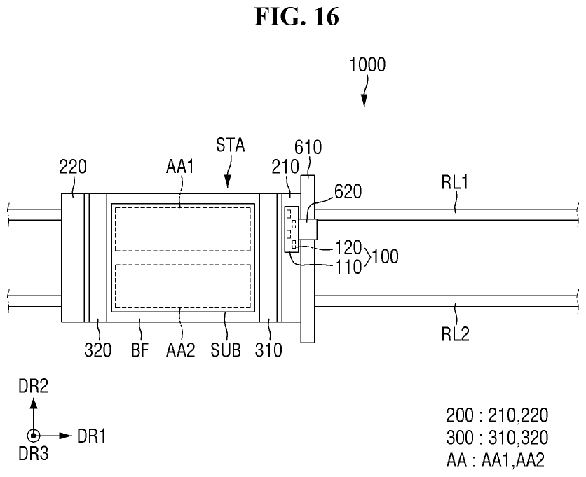

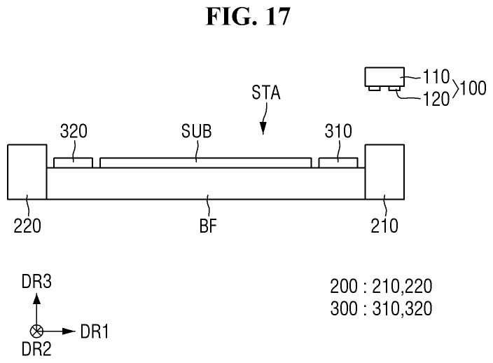

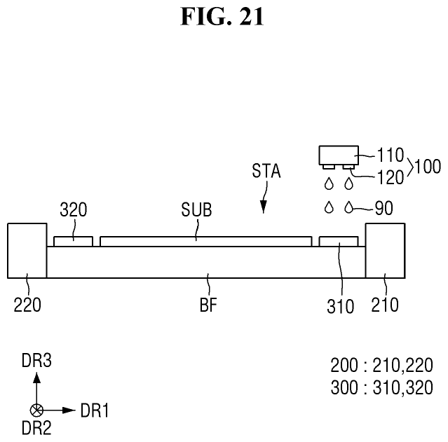

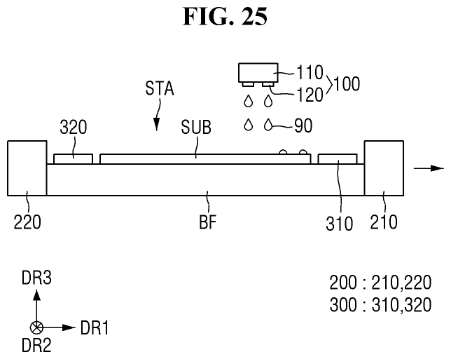

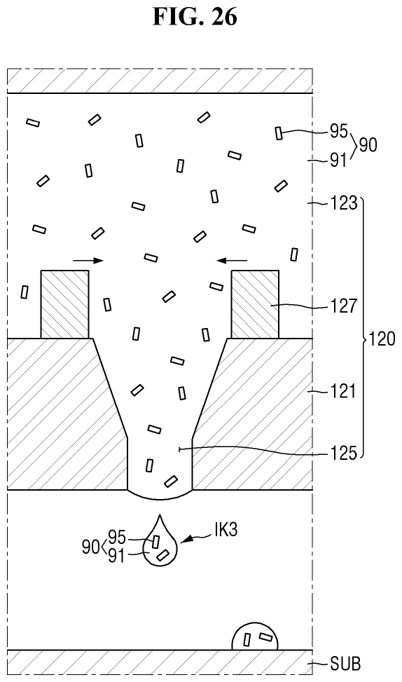

FIG. 15 is a flowchart illustrating a printing method using an inkjet printing device according to an embodiment. FIGS. 16-30 are plan views, cross-sectional views, and enlarged views schematically illustrating the printing method using the inkjet printing device used in the method of FIG. 15 (e.g., the inkjet printing device 1000 of FIGS. 5-14 according to an embodiment of the present disclosure).

Hereinafter, a printing method using the inkjet printing device 1000 according to the above-described embodiment will be described. In the following embodiment, a description of the same elements as those of the above-described embodiment will be omitted or provided briefly, and differences will be mainly described.

Referring to FIG. 15, the printing method using the inkjet printing device 1000 may include mounting a target substrate SUB on a substrate mounting part PA of a stage BF (operation S100), placing a print head unit 100, which is configured to spray ink 90 including a plurality of particles 95, above a side of the substrate mounting part PA (e.g., above the suction devices 200) not to overlap the substrate mounting part PA in the third direction DR3 and sucking at least some of the particles 95 included in the ink 90 remaining in the print head unit 100 (operation S200), placing the print head unit 100, which is configured to spray the ink 90 including the particles 95, above a preliminary jetting part 300 not to overlap the substrate mounting part PA in the third direction DR3 and pre-jetting the ink 90 including the particles 95 (operation S300), and changing relative positions of the stage BF and the print head unit 100 to position the print head unit 100 above the target substrate SUB and spraying the ink 90 including the particles 95 onto the target substrate SUB (operation S400).

For example, the printing method using the inkjet printing device 1000 according to the embodiment may include a first suction operation of placing an inkjet head 120 above a first suction area SA1 and removing particles 95 concentrated in a nozzle 125 of the inkjet head 120 using the first suction device 210, a first preliminary jetting (or spraying) operation of placing the inkjet head 120 above a first preliminary jetting area FA1 and jetting ink 90 onto a first preliminary jetting part 310, and a first spraying operation of placing the inkjet head 120 above a substrate mounting part PA and spraying the ink 90 onto a target substrate SUB. The printing method may further include a second suction operation of placing the inkjet head 120 above a second suction area SA2 and removing the particles 95 concentrated in the nozzle 125 of the inkjet head 120 using a second suction device 220, a second preliminary jetting (or spraying) operation of placing the inkjet head 120 above a second preliminary jetting area FA2 and jetting the ink onto a second preliminary jetting part 320, and a second spraying operation of placing the inkjet head 120 above the substrate mounting part PA and spraying the ink 90 onto the target substrate SUB.

First, a target substrate SUB is prepared on a substrate mounting part PA of a stage unit STA.

For example, referring to FIGS. 7, 16, and 17, the substrate SUB may be placed on a stage BF of the stage unit STA in the substrate mounting part PA.

The target substrate SUB may include a spray area AA to which ink 90 is sprayed using the inkjet printing device 1000. The spray area AA may occupy the center of the target substrate SUB. The spray area AA may include a first spray area AA1 and a second spray area AA2.

In an embodiment in which a printing process is performed as the stage unit STA moves along the first direction DR1 and a print head unit 100 moves along the second direction DR2, the first spray area AA1 may be located on an upper side of the spray area AA (e.g., a side of the second direction DR2) in a plan view, and the second spray area AA2 may be located on a lower side of the spray area AA (e.g., the other side of the second direction DR2) in a plan view.

Next, the print head unit 100 is placed above a first suction area SA1, and a plurality of particles 95 concentrated in nozzles 125 of inkjet heads 120 are sucked for a first time using a first suction device 210.

For example, referring to FIGS. 16-19, relative positions of the print head unit 100 and the stage unit STA may be adjusted so that the print head unit 100 is placed above the first suction device 210. For example, the stage unit STA may be moved in the first direction DR1 so that the print head unit 100 is placed above the first suction device 210. In some embodiments, the print head unit 100 may be moved in the second direction DR2 so that the print head unit 100 is placed above the first suction device 210 to be aligned along the first spray area AA1 of the target substrate SUB in the first direction DR1.

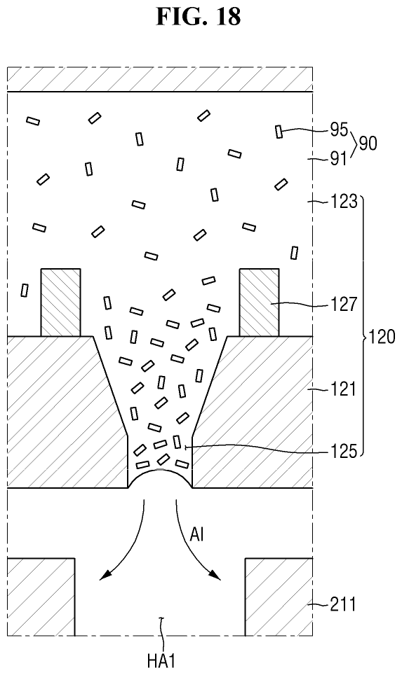

When the print head unit 100 is placed above the first suction device 210, the first suction device 210 may create (or generate) negative pressure Al in a space between each inkjet head 120 and the first suction device 210 as illustrated in FIG. 18. A first suction operation of generating the negative pressure Al between each inkjet head 120 and the first suction device 210 may be performed while the print head unit 100 and the stage unit STA do not move. That is, the first suction operation may be performed (or carried out) while the relative positions of the print head unit 100 and the stage unit STA are fixed.

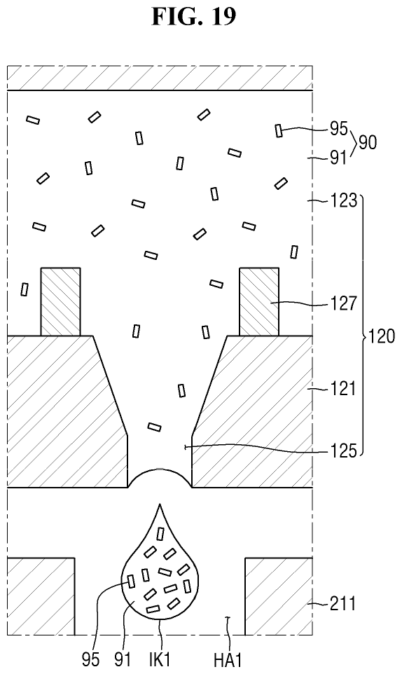

When the negative pressure Al is formed between the first suction device 210 and each inkjet head 120, ink IK1 (90, hereinafter, referred to as ‘first ink’) including a plurality of particles 95 and a solvent 91 concentrated in an area around each nozzle 125 may be sucked toward the first suction device 210 as illustrated in FIG. 19 by a force generated due to a difference between pressure inside each inkjet head 120 and pressure outside the inkjet head 120.

For example, the first ink IK1 may be sucked into suction holes HA1 of a suction body 211 of the first suction device 210. The first suction operation may be performed in a state where hydraulic pressure of the ink 90 located in a first internal tube 123 and the nozzles 125 of each inkjet head 120 and atmospheric pressure outside the inkjet head 120 are put in an equilibrium using piezoelectric elements 127. That is, the first suction operation may be performed in a non-spray mode of the inkjet heads 120. Therefore, in the first suction operation, the negative pressure Al may be generated between the first suction device 210 and the nozzles 125 of the inkjet heads 120 by using the first suction device 210, thereby forcibly removing the particles 95 concentrated in the nozzles 125.

That is, in a state where the print head unit 100 is placed above the first suction area SA1, which is a side of the substrate mounting part PA, such that the print head unit 100 and the substrate mounting part PA do not overlap each other, the first suction operation may be performed by sucking at least some of the particles 95 included in the ink 90 remaining in the print head unit 100.

Referring to FIGS. 10 and 16, the first ink IK1 sucked in the first suction operation may be collected to an ink collecting part 400 through a suction storage part 214 of the first suction device 210.

Next, the print head unit 100 is placed above a first preliminary jetting area FA1, and the ink 90 is pre-jetted onto a first preliminary jetting part 310 for a first time.

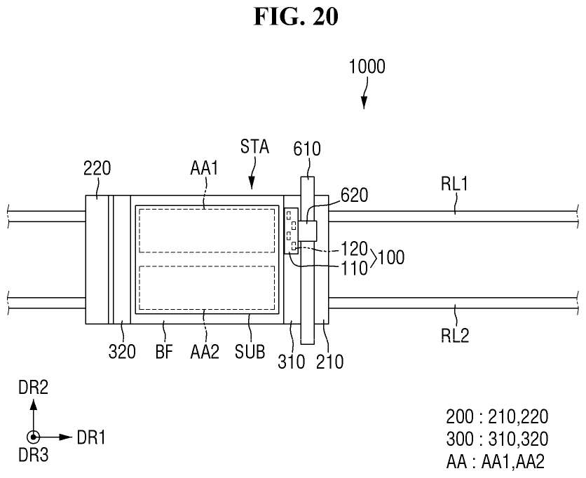

For example, referring to FIGS. 20-23, the stage unit STA may be moved in the first direction DR1 so that the print head unit 100 is placed above the first preliminary jetting part 310.

When the print head unit 100 is placed above the first preliminary jetting part 310, the inkjet heads 120 may pre-jet ink IK2 (90, hereinafter, referred to as ‘second ink’) onto the first preliminary jetting part 310. When the inkjet heads 120 are placed above the first preliminary jetting part 310, they may repeatedly jet the second ink IK2 onto the first preliminary jetting part 310 a number of times (e.g., a set or predetermined number of times). The inkjet heads 120 may jet the second ink IK2 onto the first preliminary jetting part 310 by applying a voltage (e.g., a set or predetermined voltage) to the piezoelectric elements 127.

A first preliminary jetting operation of pre-jetting the second ink IK2 from the inkjet heads 120 may be performed while the print head unit 100 and the stage unit STA do not move. That is, the first preliminary jetting operation may be performed (or carried out) while the relative positions of the print head unit 100 and the stage unit STA are fixed.

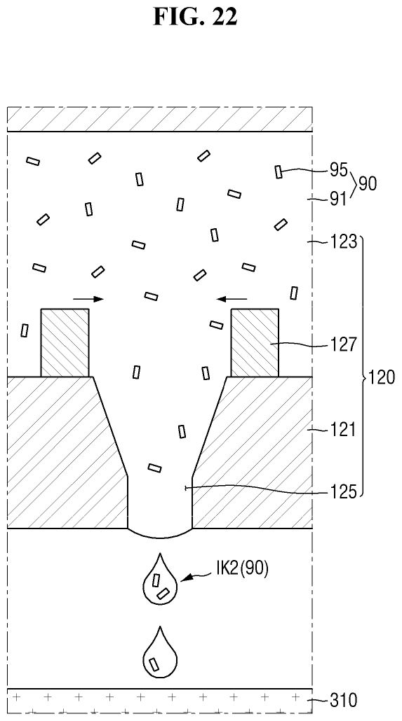

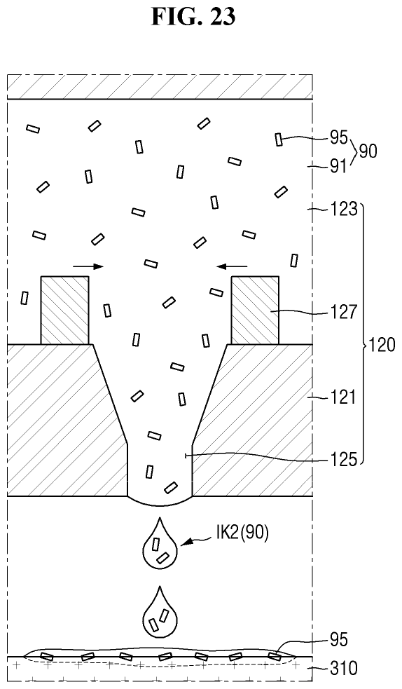

When a first suction process is performed using the first suction device 210, the degree of dispersion of the particles 95 in the ink 90 and/or the number of particles 95 included per unit volume may be different in the area around each of the nozzles 125 of the inkjet heads 120 and in other areas in the first internal tube 123 of each inkjet head 120 as illustrated in FIG. 22. Therefore, after the first suction process is performed, the number of particles 95 included in the second ink IK2 jetted through each nozzle 125 may be smaller than the reference number of particles or may be non-uniform. For this reason, the first preliminary jetting operation of jetting the second ink IK2 onto the first preliminary jetting part 310 may be performed a plurality of times so that the particles 95 are uniformly or substantially uniformly dispersed in the ink 90 flowing in the first internal tube 123 of each inkjet head 120 as illustrated in FIG. 23. Accordingly, the number of particles 95 included in the ink 90 sprayed through each nozzle 125 may be maintained uniformly or substantially uniformly.

Next, the print head unit 100 is placed above the substrate mounting part PA, and ink 90 is sprayed onto the target substrate SUB for a first time.

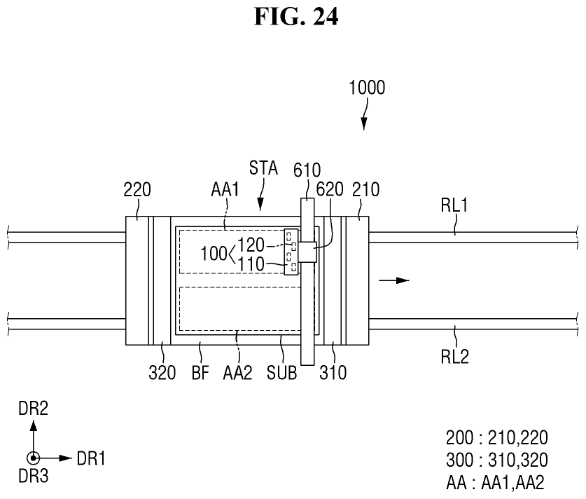

For example, referring to FIGS. 24-26, the stage unit STA may be moved in the first direction DR1 so that the print head unit 100 is placed above the target substrate SUB disposed in the substrate mounting part PA. When the print head unit 100 is placed above the substrate mounting part PA, it may spray ink IK3 (90, hereinafter, referred to as ‘third ink’) to the first spray area AA1 of the target substrate SUB.

A first spraying operation of spraying the third ink IK3 from the inkjet heads 120 onto the target substrate SUB may be performed by changing the relative positions of the print head unit 100 and the stage unit STA. That is, as the stage unit STA moves in the first direction DR1 under the print head unit 100, the third ink IK3 may be sprayed from the bottom of the print head unit 100. Accordingly, the third ink IK3 may be coated on the first spray area AA1 of the target substrate SUB. The number of particles 95 included in the third ink IK3 coated on the target substrate SUB may be uniform.

Next, the print head unit 100 is placed above a second suction area SA2, and the particles 95 concentrated in the nozzles 125 of the inkjet heads 120 are sucked for a second time using a second suction device 220.

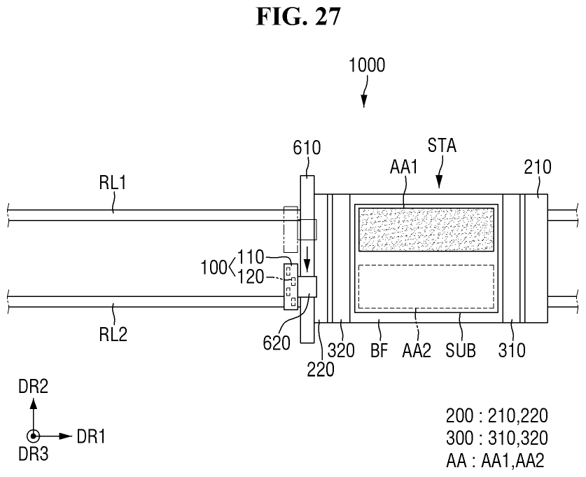

Referring to FIG. 27, a second suction operation of placing the print head unit 100 above the second suction area SA2 and removing the particles 95 concentrated in the nozzles 125 of the inkjet heads 120 using the second suction device 220 may further include moving the print head unit 100 in a direction (e.g., downward) opposite to the second direction DR2 so that the print head unit 100 is placed parallel to the second spray area AA2 of the target substrate SUB in the first direction DR1. For example, after a first spraying process of spraying the third ink IK3 to the first spray area AA1 of the target substrate SUB is performed, the print head unit 100 may be moved in the direction (e.g., downward) opposite to the second direction DR2 so that the print head unit 100 is disposed parallel to the second spray area AA2 of the target substrate SUB in the first direction DR1.

Next, the stage unit STA may be moved in a direction opposite to the first direction DR1 so that the print head unit 100 is placed above the second suction device 220.

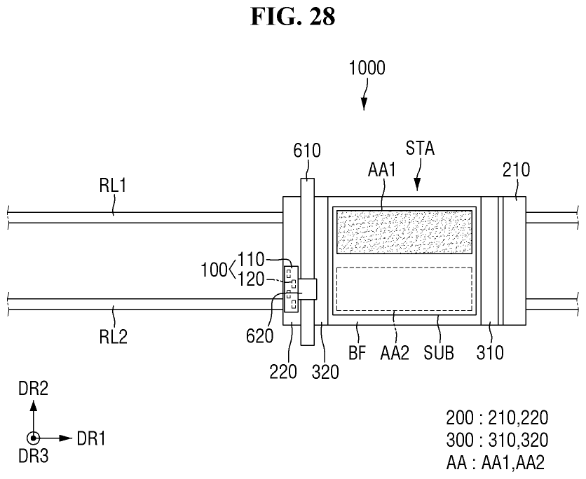

Next, referring to FIG. 28, when the print head unit 100 is placed above the second suction device 220, the second suction device 220 may generate negative pressure between the second suction device 220 and the print head unit 100. The second suction operation of generating negative pressure Al between each inkjet head 120 and the second suction device 220 may be performed while the print head unit 100 and the stage unit STA do not move. When the negative pressure is formed between the second suction device 220 and each inkjet head 120, the particles 95 concentrated in the area around each nozzle 125 may be sucked and removed by the second suction device 220 as described above by a force generated due to a difference between the pressure inside each inkjet head 120 and the pressure outside the inkjet head 120. A description of the second suction operation using the second suction device 220 will not be repeated.

Next, the print head unit 100 is placed above a second preliminary jetting area FA2, and the ink 90 is pre-jetted for a second time to a second preliminary jetting part 320.

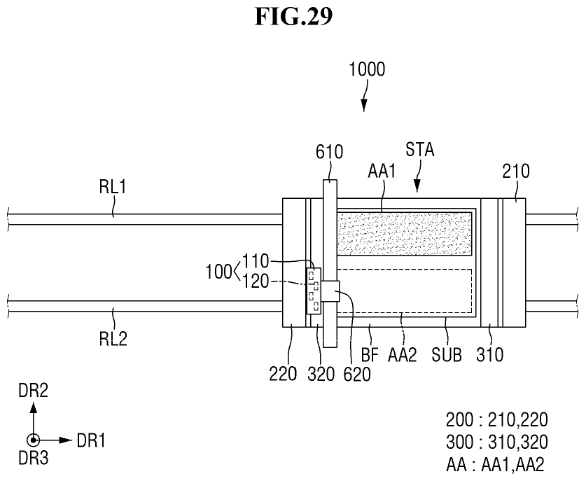

Referring to FIG. 29, the stage unit STA may be moved in the direction opposite to the first direction DR1 so that the print head unit 100 is placed above the second preliminary jetting part 320.

When the print head unit 100 is placed above the second preliminary jetting part 320, the inkjet heads 120 may pre-jet the ink 90 onto the second preliminary jetting part 320. When the inkjet heads 120 are placed above the second preliminary jetting part 320, they may repeatedly jet the ink 90 onto the second preliminary jetting part 320 a number of times (e.g., a set or predetermined number of times). A second preliminary jetting operation of pre-jetting the ink 90 from the inkjet heads 120 may be performed while the print head unit 100 and the stage unit STA do not move. By performing the second preliminary jetting operation of jetting the ink 90 onto the second preliminary jetting part 320 a plurality of times, it is possible to maintain a uniform or a substantially uniform number of particles 95 in the ink 90 sprayed through each nozzle 125. A detailed description of the second preliminary jetting operation of pre-jetting ink onto the second preliminary jetting part 320 is similar to the first preliminary jetting operation of pre-jetting ink onto the first preliminary jetting part 310 and therefore will not be repeated.

Next, the print head unit 100 is placed above the substrate mounting part PA, and ink 90 is sprayed onto the target substrate SUB for a second time.

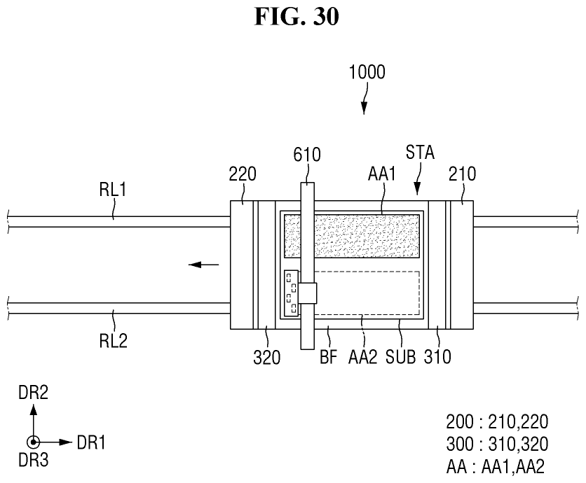

Referring to FIG. 30, the stage unit STA may be moved in the direction opposite to the first direction DR1 so that the print head unit 100 is placed above the target substrate SUB disposed in the substrate mounting part PA. When the print head unit 100 is placed above the substrate mounting part PA, it may spray the ink 90 to the second spray area AA2 of the target substrate SUB. As the stage unit STA moves the direction opposite to in the first direction DR1 under the print head unit 100, the ink 90 may be sprayed from the bottom of the print head unit 100. Accordingly, the ink 90 may be coated on the second spray area AA2 of the target substrate SUB.

In the printing method using the inkjet printing device according to the embodiment, the first suction process of removing the particles 95 concentrated in the nozzles 125 of the print head unit 100 by using the first suction device 210 and a first preliminary jetting process of pre-jetting the ink 90 onto the first preliminary jetting part 310 a number of times (e.g., a set or predetermined number of times) may be performed before the first spraying process of spraying the ink 90 to the first spray area AA1 of the target substrate SUB is performed. Therefore, during the first spraying process of spraying the ink 90 onto the first spray area AA1 of the target substrate SUB, the ink 90 having uniform quality, for example, including a uniform or a substantially uniform number of particles 95 may be sprayed. In some embodiments, a second suction process of removing the particles 95 concentrated in the nozzles 125 of the print head unit 100 by using the second suction device 220 and a second preliminary jetting process of pre-jetting the ink 90 onto the second preliminary jetting part 320 a number of times (e.g., a set or predetermined number of times) may be performed between the first spraying process of spraying the ink 90 to the first spray area AA1 and a second spraying process of spraying the ink 90 to the second spray area AA2, that is, in a printing standby state between the first spraying process and the second spraying process. Therefore, during the second spraying process of spraying the ink 90 onto the second spray area AA2 of the target substrate SUB, the ink 90 having uniform quality, for example, including a uniform a substantially uniform number of particles 95 may be sprayed.

That is, by performing a suction process using a suction device 200 (e.g., 210, 220) and a preliminary jetting process using a preliminary jetting part 300 (e.g., 310, 320) in the printing standby state before each spraying process is performed, it is possible to prevent the nozzles 125 from being clogged with the particles 95 concentrated in the nozzles 125 at the initial time of a printing process (e.g., a spraying process) performed immediately or substantially immediately after the printing standby state. In some embodiments, it is possible to prevent the occurrence of an over-jetting phenomenon in which the number of particles 95 included in the ink 90 jetted at the initial time of the printing process (e.g., the spraying process) performed immediately or substantially immediately after the printing standby state is excessively large or prevent the occurrence of an under-jetting phenomenon in which the number of particles 95 is excessively small. Therefore, the number of particles 95 included in the ink 90 jetted while the spraying process of spraying the ink 90 onto the target substrate SUB is performed may be maintained immediately or substantially uniformly, thereby improving the reliability of the printing process using the inkjet printing device 1000 and enhancing the quality of the display device 10.

In some embodiments, because a plurality of particles concentrated in nozzles 125 are sucked and removed by generating negative pressure on the print head unit 100 before a preliminary jetting process is performed, a preliminary jetting process time for normalizing the number of particles 95 in the ink 90 jetted through the nozzles 125 is reduced, thereby improving the printing process efficiency.

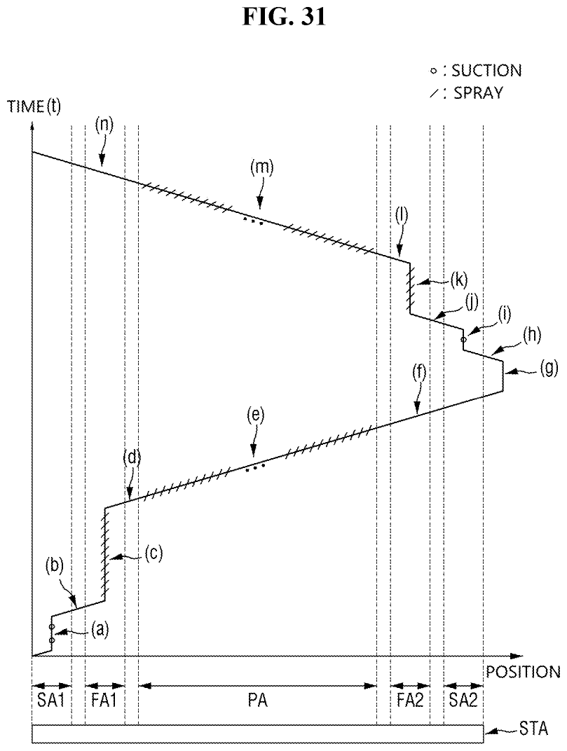

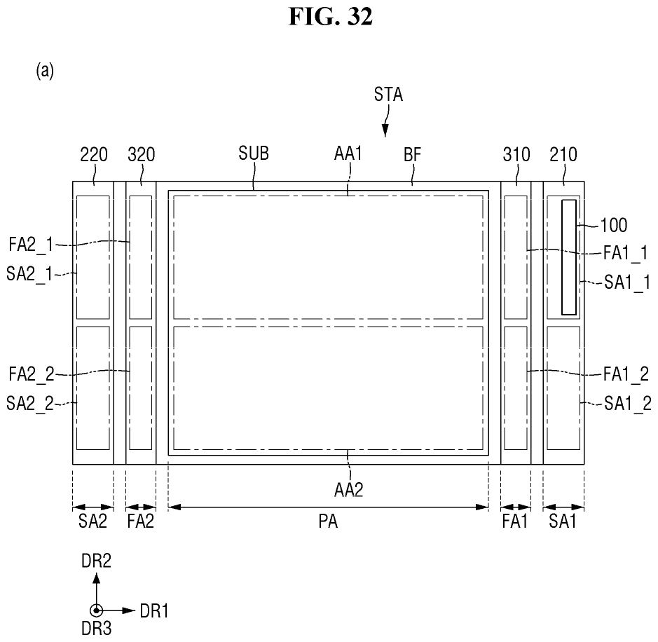

FIG. 31 is a graph illustrating a process time according to a relative position between the print head unit 100 and each area (e.g., AA1, AA2) of the stage unit STA in a printing process performed using the inkjet printing device 1000 according to the embodiment. FIGS. 32-45 are plan views schematically illustrating a printing process performed using the inkjet printing device 1000 used in the method of FIG. 15 (e.g., the inkjet printing device 1000 of FIGS. 5-30) according to an embodiment of the present disclosure.

The X-axis of the graph illustrated in FIG. 31 represents the relative position between the stage unit STA and the print head unit 100, and the Y-axis represents a process time t during which a printing process is performed. The relative position between the stage unit STA and the print head unit 100 may mean that the print head unit 100 is disposed above each area of the stage unit STA to overlap it in the third direction DR3.

FIGS. 32-45 illustrate relative planar arrangement relationships between the stage unit STA and the print head unit 100 corresponding to areas (a) through (n) of the graph of FIG. 31, respectively. A printing method using the inkjet printing device 1000 will now be described with reference to FIGS. 31-45, focusing on a process performed according to the position of the print head unit 100 above the stage unit STA, a process time, and the number of processes. The number of processes shown in the graph of FIG. 31 is merely an example for describing the printing method, and the number of processes is not limited thereto.

Referring to FIG. 32, as described above, the target substrate SUB prepared on the substrate mounting part PA of the stage unit STA may include the spray area AA including the first spray area AA1 and the second spray area AA2.

The first suction area SA1 of the stage unit STA may include a first area SA1_1 (hereinafter, referred to as a ‘first area of the first suction area’) and a second area SA1_2 (hereinafter, referred to as a ‘second area of the first suction area’). The first area SA1_1 of the first suction area may be an area disposed in the first suction area SA1 to be parallel to the first spray area AA1 in the first direction DR1, and the second area SA1_2 of the first suction area may be an area disposed in the first suction area SA1 to be parallel to the second spray area AA2 in the first direction DR1.

Likewise, the second suction area SA2 of the stage unit STA may include a first area SA2_1 (hereinafter, referred to as a ‘first area of the second suction area’) and a second area SA2_2 (hereinafter, referred to as a ‘second area of the second suction area’). The first area SA2_1 of the second suction area may be an area disposed in the second suction area SA2 to be parallel to the first spray area AA1 in the first direction DR1, and the second area SA2_2 of the second suction area may be an area disposed in the second suction area SA2 to be parallel to the second spray area AA2 in the first direction DR1.

The first preliminary jetting area FA1 of the stage unit STA may include a first area FA1_1 (hereinafter, referred to as a ‘first area of the first preliminary jetting area’) and a second area FA1_2 (hereinafter, referred to as a ‘second area of the first preliminary jetting area’). The first area FA1_1 of the first preliminary jetting area may be an area disposed in the first preliminary jetting area FA1 to be parallel to the first spray area AA1 in the first direction DR1, and the second area FA1_2 of the first preliminary jetting area may be an area disposed in the first preliminary jetting area FA1 to be parallel to the second spray area AA2 in the first direction DR1.

Likewise, the second preliminary jetting area FA2 of the stage unit STA may include a first area FA2_1 (hereinafter, referred to as a ‘first area of the second preliminary jetting area’) and a second area FA2_2 (hereinafter, referred to as a ‘second area of the second preliminary jetting area’). The first area FA2_1 of the second preliminary jetting area may be an area disposed in the second preliminary jetting area FA2 to be parallel to the first spray area AA1 in the first direction DR1, and the second area FA2_2 of the second preliminary jetting area may be an area disposed in the second preliminary jetting area FA2 to be parallel to the second spray area AA2 in the first direction DR1.

First, referring to area (a) of FIG. 31 and FIG. 32, the print head unit 100 may be placed above the first area SA1_1 of the first suction area of the stage unit STA, and a first suction process (area (a) of FIG. 31) may be performed. When the print head unit 100 is placed above the first area SA1_1 of the first suction area, the first suction process (area (a)) may be performed while the print head unit 100 is fixed above the first area SA1_1 of the first suction area. The number of suction operations that generate negative pressure on the print head unit 100 in the first suction process (area (a)) may vary depending on the printing standby time. For example, the number of first suction operations that generate negative pressure on the print head unit 100 in the first suction process (area (a)) may be, but is not limited to, two.

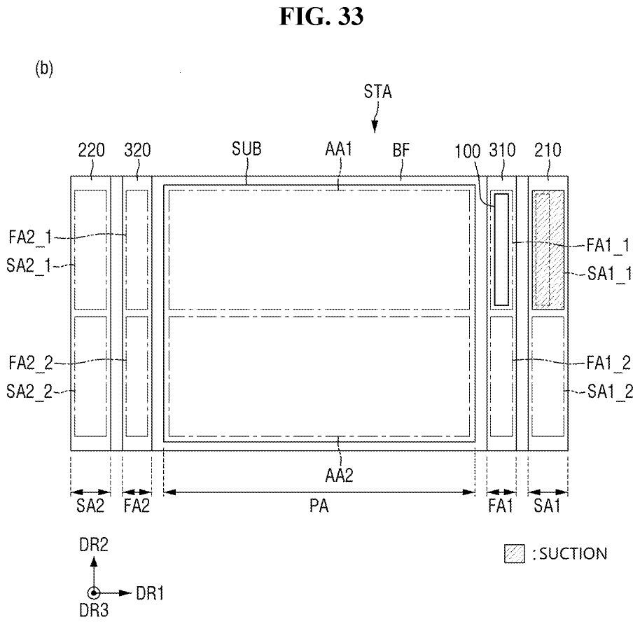

Next, referring to area (b) of FIG. 31 and FIG. 33, the print head unit 100 may move for a first time from the first area SA1_1 of the first suction area of the stage unit STA to the first area FA1_1 of the first preliminary jetting area (area (b) of FIG. 31). For example, the print head unit 100 may move horizontally in a direction parallel to the first direction DR1 from the first area SA1_1 of the first suction area of the stage unit STA to the first area FA1_1 of the first preliminary jetting area. The movement (arrow) of the print head unit 100 illustrated in the drawings shows the relative planar arrangement relationship between the stage unit STA and the print head unit 100. That is, the movement (arrow) of the print head unit 100 to the left in a plan view in the drawings may include a case where the print head unit 100 is moved to the left above the stage unit STA while the stage unit STA is fixed or a case where the stage unit STA is moved to the right while the print head unit 100 is fixed so that the print head unit 100 is moved to above the first area FA1_1 of the first preliminary jetting area.

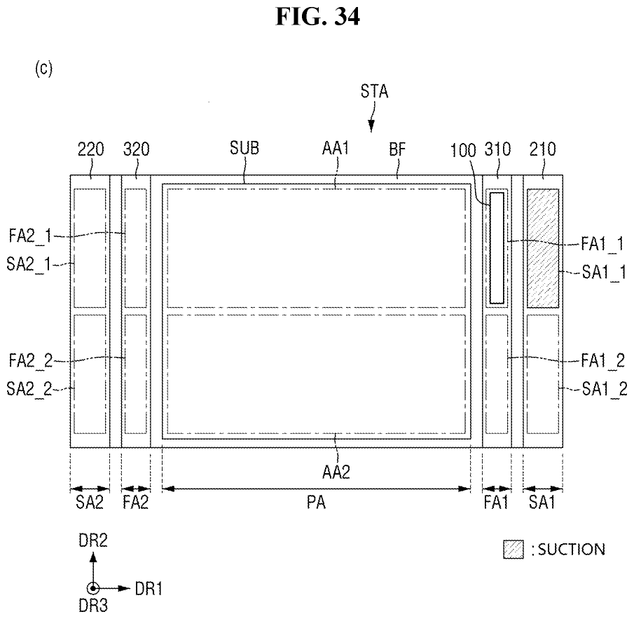

Next, referring to area (c) of FIG. 31 and FIG. 34, the print head unit 100 may be placed above the first area FA1_1 of the first preliminary jetting area of the stage unit STA, and a first preliminary jetting process (area (c) of FIG. 31) may be performed. When the print head unit 100 is placed above the first area FA1_1 of the first preliminary jetting area, the first preliminary jetting process (area (c)) may be performed while the print head unit 100 is fixed above the first area FA1_1 of the first preliminary jetting area. The number of first preliminary jetting operations, that is, the number of times that the print head unit 100 jets the ink 90 in the first preliminary jetting process (area (c)) may vary depending on the printing standby time. For example, the number of first preliminary jetting operations, that is, the number of times that the print head unit 100 jets the ink 90 in the first preliminary jetting process (area (c)) may be, but is not limited to, ten times.

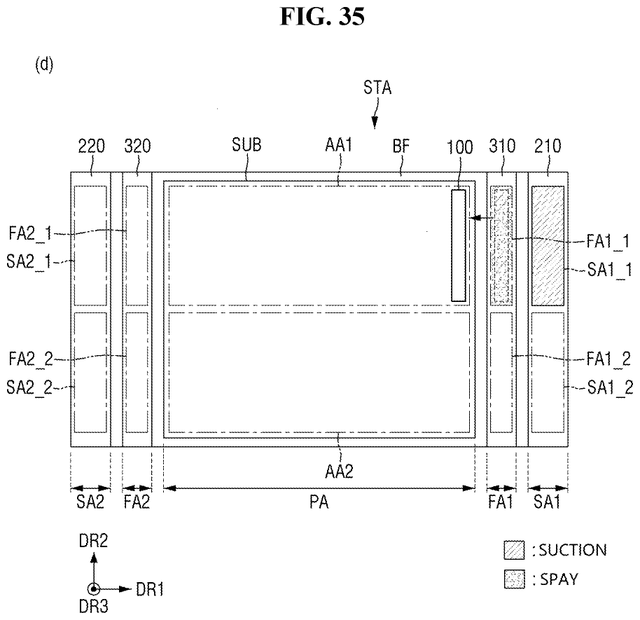

Next, referring to area (d) of FIG. 31 and FIG. 35, the print head unit 100 may move for a second time from the first area FA1_1 of the first preliminary jetting area of the stage unit STA to the first spray area AA1 of the target substrate SUB disposed in the substrate mounting part PA (area (d) of FIG. 31). For example, the print head unit 100 may move horizontally in the direction parallel to the first direction DR1 from the first area FA1_1 of the first preliminary jetting area of the stage unit STA to the first spray area AA1 of the target substrate SUB. In some embodiments, the print head unit 100 may be placed from over the first area FA1_1 of the first preliminary jetting area of the stage unit STA to the first spray area AA1 of the target substrate SUB disposed in the substrate mounting part PA (area (d) of FIG. 31) by moving the stage unit STA in the first direction DR1.

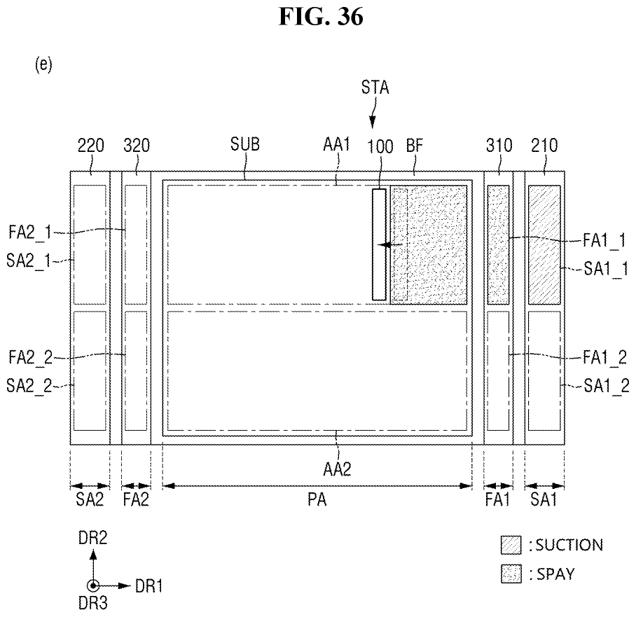

Next, referring to area (e) of FIG. 31 and FIG. 36, when the print head unit 100 is placed in the substrate mounting part PA, a first spraying process (area (e) of FIG. 31) may be performed. For example, when the print head unit 100 is placed above the first spray area AA1 of the target substrate SUB, the first spraying process (area (e)) may be performed. The first spraying process (area (e)) may be performed as the print head unit 100 moves horizontally above the first spray area AA1 in the direction parallel to the first direction DR1. The number of first spraying operations, that is, the number of times that the print head unit 100 jets the ink 90 in the first spraying process (area (e)) may be greater than the number of first preliminary jetting operations.

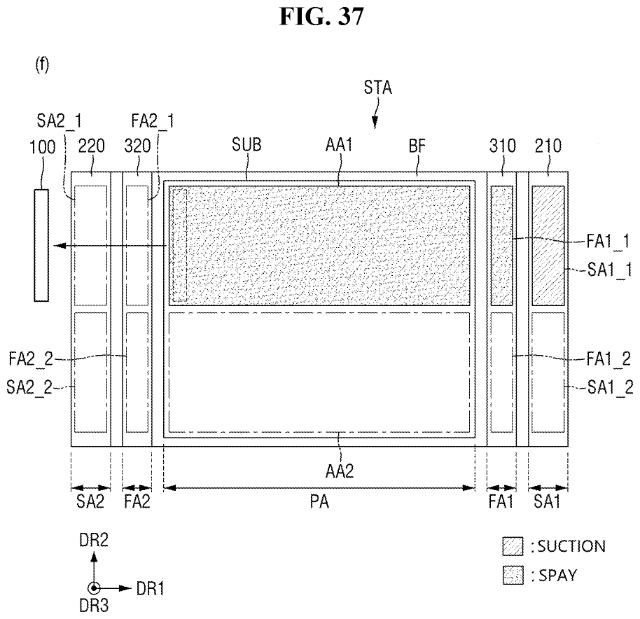

Next, referring to area (f) of FIG. 31 and FIG. 37, the print head unit 100 may move for a third time from the substrate mounting part PA of the stage unit STA to the outside of the stage unit STA (area (f) of FIG. 31). For example, the print head unit 100 may move horizontally in the direction parallel to the first direction DR1 from the substrate mounting part PA to the outside of the stage unit STA. While moving for the third time, the print head unit 100 may move above the stage unit STA in the direction parallel to the first direction DR1 and pass through the first area FA2_1 of the second preliminary jetting area and the first area SA2_1 of the second suction area under the print head unit 100. That is, while the print head unit 100 moves horizontally above the first area FA2_1 of the second preliminary jetting area and the first area SA2_1 of the second suction area, a preliminary jetting process and a suction process may not be performed in the first area FA2_1 of the second preliminary jetting area and the first area SA2_1 of the second suction area.

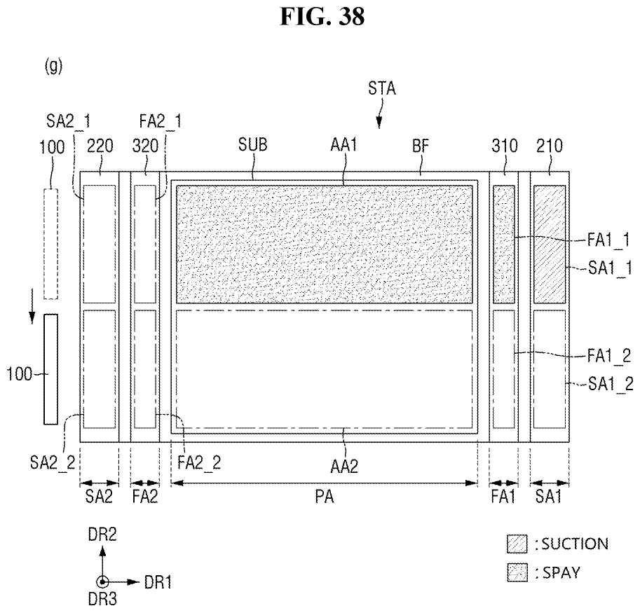

Next, referring to area (g) of FIG. 31 and FIG. 38, the print head unit 100 may move for a fourth time so that it is placed parallel to the second spray area AA2 of the target substrate SUB in the first direction DR1 (area (g) of FIG. 31). For example, the print head unit 100 may move horizontally in a direction parallel to the second direction DR2 so that it is positioned parallel to the second spray area AA2 of the target substrate SUB in the first direction DR1.

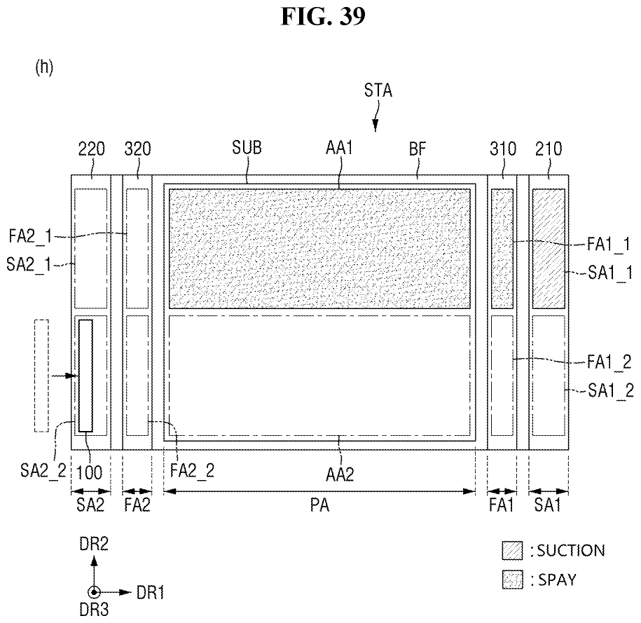

Next, referring to area (h) of FIG. 31 and FIG. 39, the print head unit 100 may move for a fifth time from the outside of the stage unit STA to the second area SA2_2 of the second suction area (area (h) of FIG. 31). For example, the print head unit 100 may move horizontally in the direction parallel to the first direction DR1 from the outside of the stage unit STA to the second area SA2_2 of the second suction area of the stage unit STA.

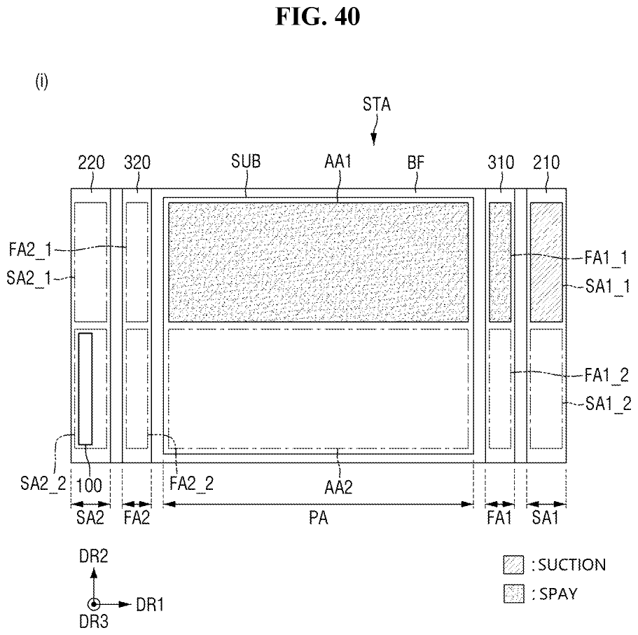

Next, referring to area (i) of FIG. 31 and FIG. 40, the print head unit 100 may be placed above the second area SA2_2 of the second suction area of the stage unit STA, and a second suction process (area (i) of FIG. 31) may be performed. When the print head unit 100 is placed above the second area SA2_2 of the second suction area, the second suction process (area (i)) may be performed while the print head unit 100 is fixed above the second area SA2_2 of the second suction area. The number of suction operations that generate negative pressure on the print head unit 100 in the second suction process (area (i)) may vary depending on the printing standby time. The number of second suction operations that generate negative pressure on the print head unit 100 in the second suction process (area (i)) may be smaller than the number of first suction operations. In some embodiments, a second suction process time during which the second suction process (area (i)) is performed may be shorter than a first suction process time during which the first suction process (area (a)) is performed. For example, the number of second suction operations that generate negative pressure on the print head unit 100 in the second suction process (area (i)) may be, but is not limited to, one.

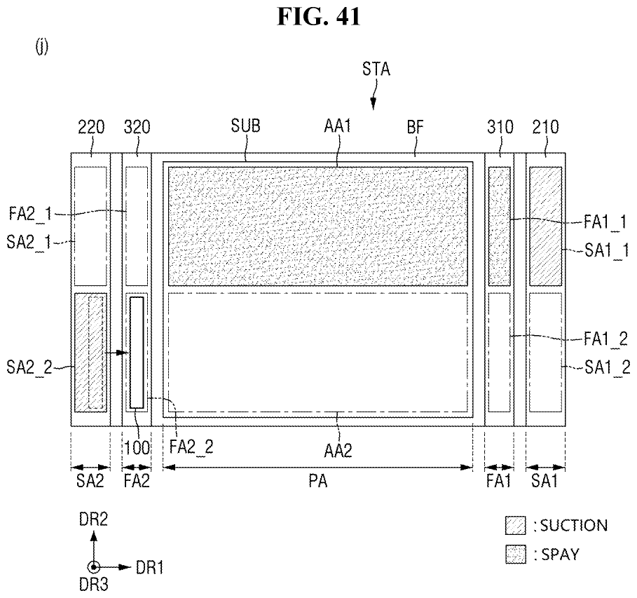

Next, referring to area (j) of FIG. 31 and FIG. 41, the print head unit 100 may move for a sixth time from the second area SA2_2 of the second suction area of the stage unit STA to the second area FA2_2 of the second preliminary jetting area (area (j) of FIG. 31). For example, the print head unit 100 may move horizontally in the direction parallel to the first direction DR1 from the second area SA2_1 of the second suction area of the stage unit STA to the second area FA2_2 of the second preliminary jetting area.

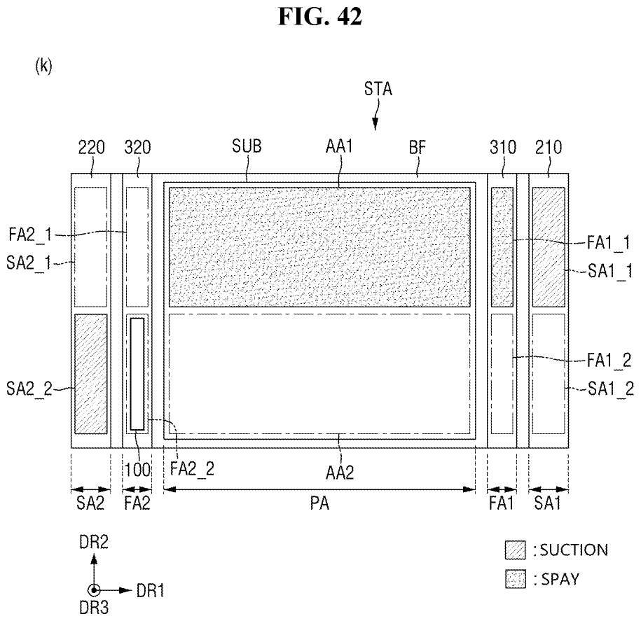

Next, referring to area (k) of FIG. 31 and FIG. 42, the print head unit 100 may be placed above the second area FA2_2 of the second preliminary jetting area of the stage unit STA, and a second preliminary jetting process (area (k) of FIG. 31) may be performed. When the print head unit 100 is placed above the second area FA2_2 of the second preliminary jetting area, the second preliminary jetting process (area (k)) may be performed while the print head unit 100 is fixed above the second area FA2_2 of the second preliminary jetting area. The number of second preliminary jetting operations, that is, the number of times that the print head unit 100 jets the ink 90 in the second preliminary jetting process (area (k)) may vary depending on the printing standby time. The number of second preliminary jetting operations, that is, the number of times that the print head unit 100 jets the ink 90 in the second preliminary jetting process (area (k)) may be smaller than the number of first preliminary jetting operations. In some embodiments, a second preliminary jetting process time during which the second preliminary jetting process (area (k)) is performed may be shorter than a first preliminary jetting process time during which the first preliminary jetting process (area (c)) is performed. For example, the number of second preliminary jetting operations, that is, the number of times that the print head unit 100 jets the ink 90 in the second preliminary jetting process (area (k)) may be, but is not limited to, five times.

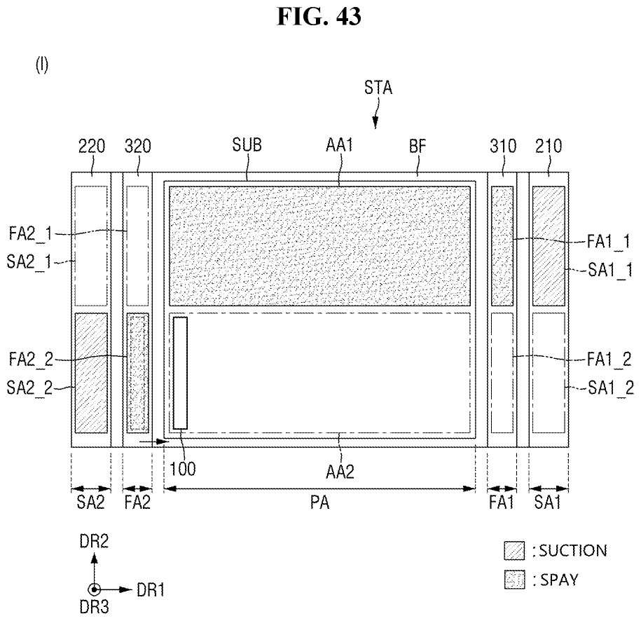

Next, referring to area (l) of FIG. 31 and FIG. 43, the print head unit 100 may move for a seventh time from the second area FA2_2 of the second preliminary jetting area of the stage unit STA to the second spray area AA2 of the target substrate SUB in the substrate mounting part PA (area (l) of FIG. 31). For example, the print head unit 100 may move horizontally in the direction parallel to the first direction DR1 from the second area FA2_2 of the second preliminary jetting area of the stage unit STA to the second spray area AA2 of the target substrate SUB.

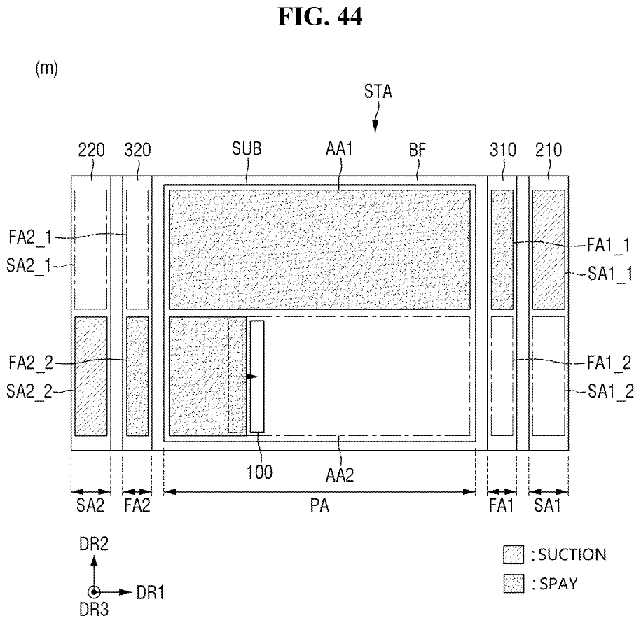

Next, referring to area (m) of FIG. 31 and FIG. 44, when the print head unit 100 is placed in the substrate mounting part PA, a second spraying process (area (m) of FIG. 31) may be performed. For example, when the print head unit 100 is placed above the second spray area AA2 of the target substrate SUB, the second spraying process (area (m)) may be performed. The second spraying process (area (m)) may be performed as the print head unit 100 moves above the second spray area AA2 of the target substrate SUB in the direction perpendicular to the first direction DR1. The number of second spraying operations, that is, the number of times that the print head unit 100 jets the ink 90 in the second spraying process (area (m)) may be equal to the number of first spraying operations.

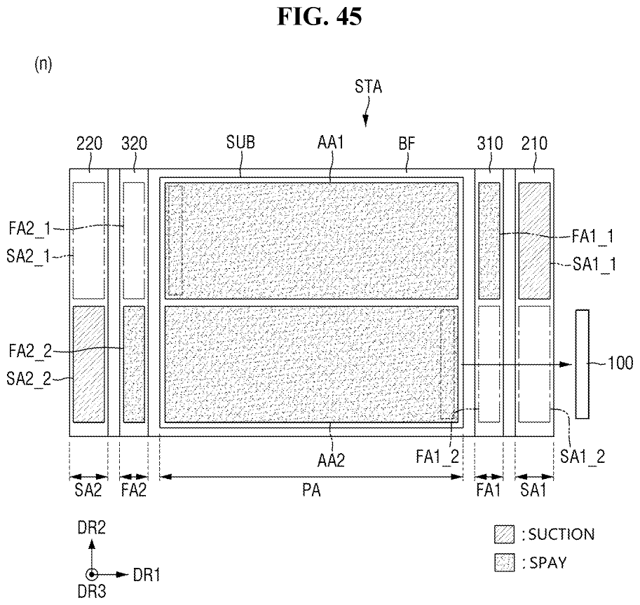

Next, referring to area (n) of FIG. 31 and FIG. 45, the print head unit 100 may move for an eighth time from the substrate mounting part PA of the stage unit STA to the outside of the stage unit STA (area (n) of FIG. 31). For example, the print head unit 100 may move horizontally in the direction parallel to the first direction DR1 from the substrate mounting part PA to the outside of the stage unit STA. While moving for the eighth time, the print head unit 100 may move above the stage unit STA in the direction parallel to the first direction DR1 and pass through the second area FA1_2 of the first preliminary jetting area and the second area SA1_2 of the first suction area under the print head unit 100. That is, while the print head unit 100 moves horizontally above the second area FA1_2 of the first preliminary jetting area and the second area SA1_2 of the first suction area, a preliminary jetting process and a suction process may not be performed in the second area FA1_2 of the first preliminary jetting area and the second area SA1_2 of the first suction area.

Hereinafter, other embodiments will be described. In the following embodiments, a redundant description of the same elements as those already described above will not be repeated or given briefly, and differences will be mainly described.

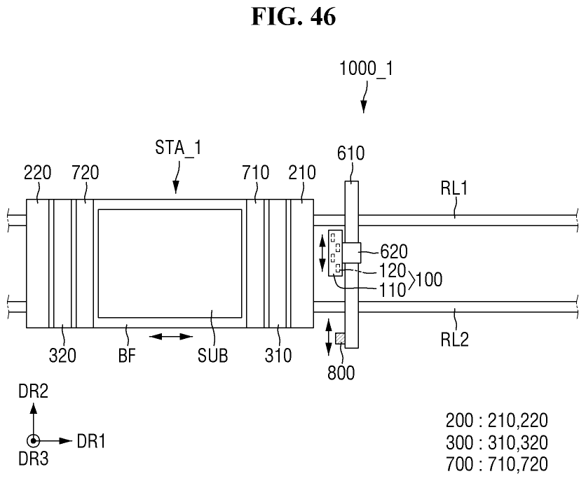

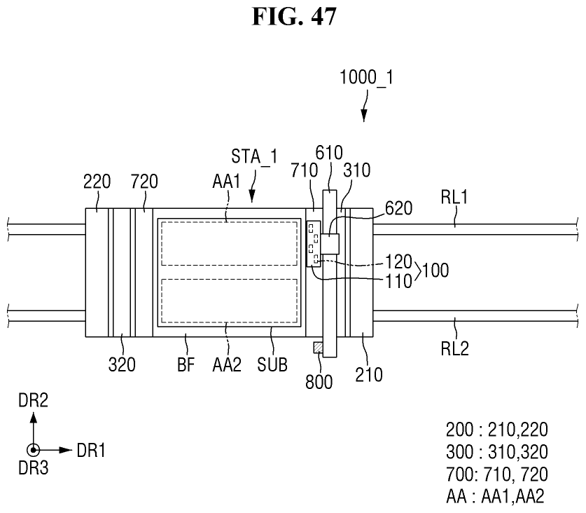

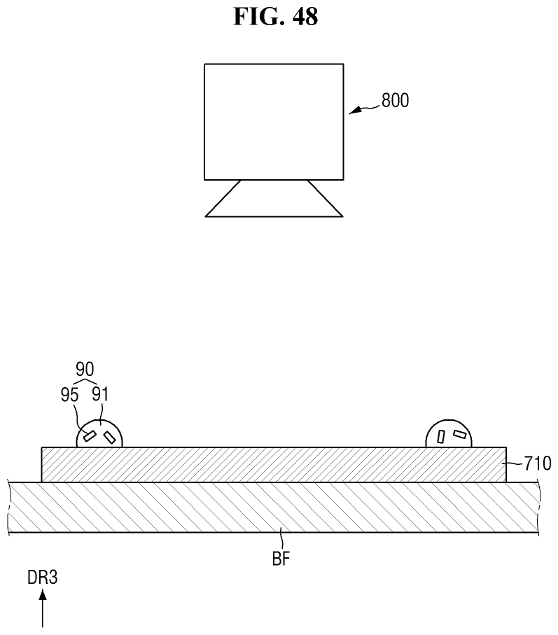

FIG. 46 is a schematic plan view of an inkjet printing device 1000_1 according to an embodiment. FIG. 47 is a schematic plan view illustrating a part of a printing process performed using the inkjet printing device 1000_1 of FIG. 46. FIG. 48 is a schematic cross-sectional layout view illustrating an example of a first inspection unit 800 and a first dummy part 710 of the inkjet printing device 1000_1 of FIG. 46.

Referring to FIG. 46, the inkjet printing device 1000_1 according to the current embodiment may include a stage unit STA_1 further including dummy parts 700 (e.g., 710, 720) and the first inspection unit 800.

While a printing process of spraying ink 90 onto a target substrate SUB is performed, the same amount of ink 90 needs to be sprayed from a print head unit 100 to the same position. Therefore, a process of spraying the ink 90 onto the dummy parts 700 and inspecting the ink 90 may be performed before the ink 90 is sprayed from the print head unit 100 onto the target substrate SUB. Then, a set value of the inkjet printing device 1000_1 may be adjusted according to the inspection result.

The dummy parts 700 according to an embodiment may be disposed on a stage BF. The dummy parts 700 may include glass, film, etc., but are not limited to a particular type. For example, each of the dummy parts 700 may include an organic film or a transparent glass substrate.

The dummy parts 700 may include the first dummy part 710 and a second dummy part 720. The first dummy part 710 may be disposed between a substrate mounting part PA (see FIG. 7) in which the target substrate SUB is disposed on the stage BF and a first preliminary jetting part 310. The second dummy part 720 may be disposed between the substrate mounting part PA in which the target substrate SUB is disposed on the stage BF and a second preliminary jetting part 320.

The first inspection unit 800 may be mounted on a first support 610. The first inspection unit 800 may be mounted on a first horizontal support part 611 of the first support 610.

Referring to FIGS. 47 and 48, after a first preliminary jetting process of pre-jetting the ink 90 onto the first preliminary jetting part 310 is performed, the stage unit STA_1 may move along the first direction DR1 so that the print head unit 100 is placed above the first dummy part 710. When the print head unit 100 is placed above the first dummy part 710, the ink 90 may be sprayed from the print head unit 100 onto the first dummy part 710.

When the ink 90 is sprayed from the print head unit 100 onto the first dummy part 710, the first inspection unit 800 may find out the amount of droplets, impact position, etc. of the ink 90 sprayed from the print head unit 100 by analyzing the ink 90 coated on the first dummy part 710.

The first inspection unit 800 may be placed above the first dummy part 710 to detect or photograph the ink 90 coated on the first dummy part 710. In an embodiment, the first inspection unit 800 may be a high-resolution camera. When the first inspection unit 800 is a high-resolution camera, the first inspection unit 800 may be placed above the first dummy part 710 to photograph the first dummy part 710 disposed under the first inspection unit 800 and measure diameters or positions of materials (e.g., the ink 90) coated on the first dummy part 710 and an error between them. However, the first inspection unit 800 is not limited to a high-resolution camera as long as it can detect the materials coated on the first dummy part 710.

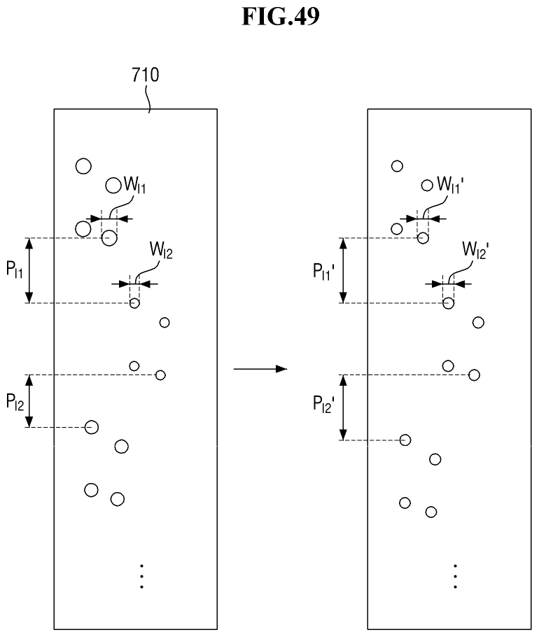

FIG. 49 is a schematic view illustrating ink coated on the first dummy part 710 according to an embodiment.

A method of inspecting the jetted amount of ink 90 coated on an upper surface of the first dummy part 710 will now be described with reference to FIGS. 46-49.

The first inspection unit 800 may analyze image data generated by photographing the first dummy part 710 and measure the diameter and coated position of the ink 90 by calculating the diameter and coated position of the ink 90 coated on the upper surface of the first dummy part 710.

For example, diameters W_{I1} and W_{I2} of droplets of ink 90 coated on the upper surface of the first dummy part 710 and distances P_{I1} and P_{I2} between two droplets of coated ink 90 spaced from each other may be measured. The measured diameters W_{I1} and W_{I2} of and distances P_{I1} and P_{I2} between the droplets of ink 90 may be compared with reference set values, and the amount of ink 90 sprayed from the print head unit 100 and the position of an ink jetting member of the print head unit 100 may be adjusted to be close to the reference set values based on the comparison result.

The first inspection unit 800 may adjust the number of particles 95 dispersed in the ink 90 jetted once by measuring the diameters W_{I1} and W_{I2} of the droplets of ink 90 coated on the upper surface of the first dummy part 710. When the diameters W_{I1} and W_{I2} of the droplets of ink 90 are different from each other, the reliability of a product manufactured using the inkjet printing device 1000_1 may be low. Therefore, the first inspection unit 800 may detect this error and match the diameters W_{I1}′ and W_{I2}′ of the droplets of ink 90 by adjusting the amount of ink 90 sprayed from the print head unit 100, thereby maintaining the number of particles 95 in the ink 90 jetted once.

An inspection process using a dummy part 700 and the first inspection unit 800 may be repeated until the diameters W_{I1}′ and W_{I2}′ of and distances P_{I1}′ and P_{I2}′ between the droplets of ink 90 are equal or substantially equal or close to the reference set values. The ‘reference set values’ may be the ‘characteristic values’ required for the print head unit 100 that sprays the ink 90 including the particles 95 when the inkjet printing device 1000_1 is driven. For example, the reference set values may include the amount of ink 90 sprayed from each nozzle 125 of the print head unit 100, the coated position of the ink 90, and the number of particles 95 included in the ink 90.

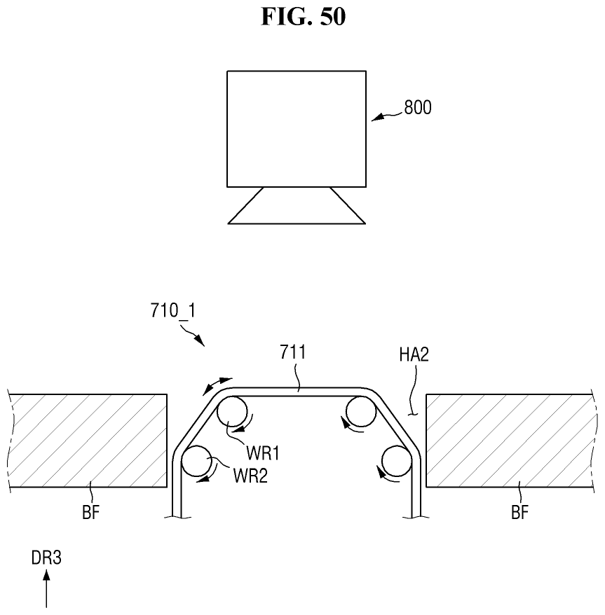

FIG. 50 is a schematic cross-sectional layout view illustrating an example of the first dummy part 710 of FIG. 46.

Referring to FIG. 50, a first dummy part 710_1 according to the current embodiment may be disposed in an opening HA2 penetrating the stage BF. The first dummy part 710_1 may include a plurality of rolls WR1 and WR2 and a dummy film 711 wound by the rolls WR1 and WR2.

The rolls WR1 and WR2 may include a first roll WR1 and a second roll WR2 spaced from the first roll WR1. The dummy film 711 may be wound in the first direction DR1 in a plan view according to the rotation of the first roll WR1 and the second roll WR2. In the first dummy part 710_1, the dummy film 700 may be provided on and/or removed from the stage BF by the rolls WR1 and WR2. Ink 90 may be sprayed onto the dummy film 711.

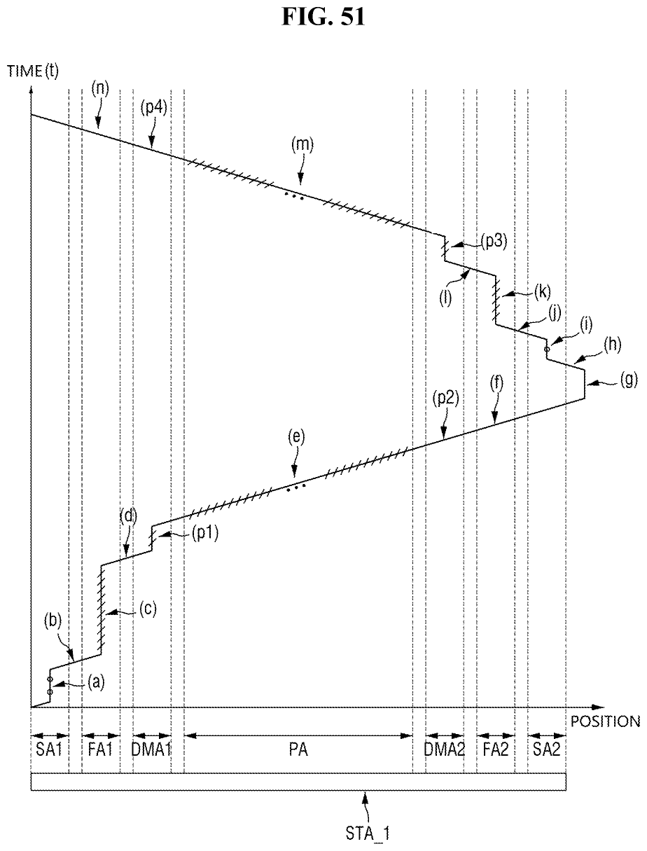

FIG. 51 is a graph illustrating a process time according to a relative position between the print head unit 100 and each area of the stage unit STA_1 in a printing process performed using the inkjet printing device 1000_1 of FIG. 46.

Referring to FIG. 51, the stage unit STA_1 may further include first and second dummy areas DMA1 and DMA2. The first dummy area DMA1 may be disposed between a first preliminary jetting area FA1 and the substrate mounting part PA, and the second dummy area DMA2 may be disposed between a second preliminary jetting area FA2 and the substrate mounting part PA. The first dummy part 710 may be disposed in the first dummy area DMA1, and the second dummy part 720 may be disposed in the second dummy area DMA2.

A printing method using the inkjet printing device 1000_1 of FIG. 46 may further include a first inspection process (area (p1)) of spraying ink 90 onto the first dummy area DMA1 between a first preliminary jetting process (area (c)) and a first spraying process (area (e)) and a second inspection process (area (p3)) of spraying the ink 90 onto the second dummy area DMA2 between a second preliminary jetting process (area (k)) and a second spraying process (area (m)).

When the print head unit 100 is placed above the first dummy area DMA1, the first inspection process (area (p1)) may be performed while the print head unit 100 is fixed above the first dummy area DMA1. The number of first inspection jetting operations, that is, the number of times that the print head unit 100 jets the ink 90 in the first inspection jetting process (area (p1)) may be suitably determined (e.g., set or predetermined). For example, the number of first inspection jetting operations may be smaller than the numbers of first and second preliminary jetting operations. In some embodiments, a first inspection jetting process time during which the first inspection jetting process (area (p1)) is performed may be shorter than first and second preliminary jetting process times during which the first and second preliminary jetting processes (areas (c) and (k)) are performed. For example, the number of first inspection jetting operations, that is, the number of times that the print head unit 100 jets the ink 90 in the first inspection jetting process (area (p1)) may be, but is not limited to, twice.

When the print head unit 100 is placed above the second dummy area DMA2, the second inspection jetting process (area (p3)) may be performed while the print head unit 100 is fixed above the second dummy area DMA2. The number of second inspection jetting operations, that is, the number of times that the print head unit 100 jets the ink 90 in the second inspection jetting process (area (p3)) and an inspection jetting process time may be substantially the same as those in the first inspection jetting process (area (p1)).

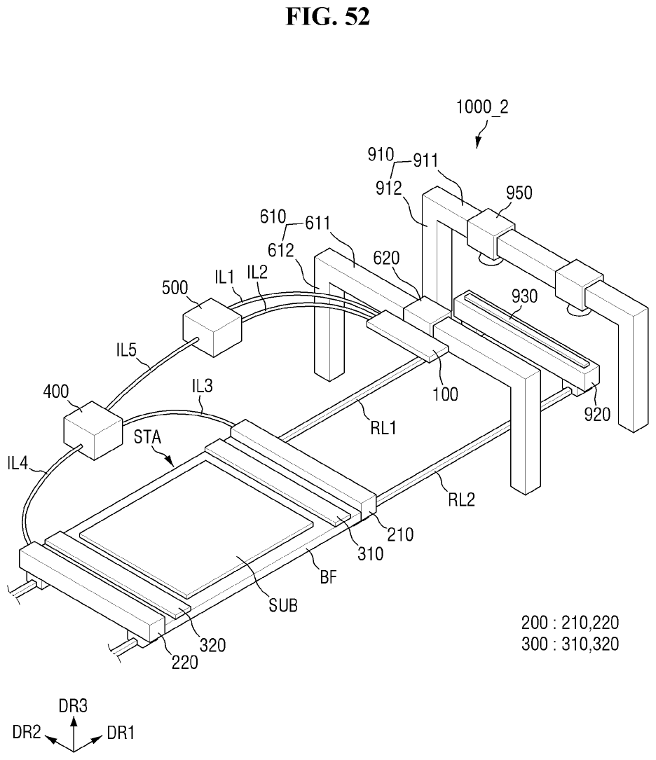

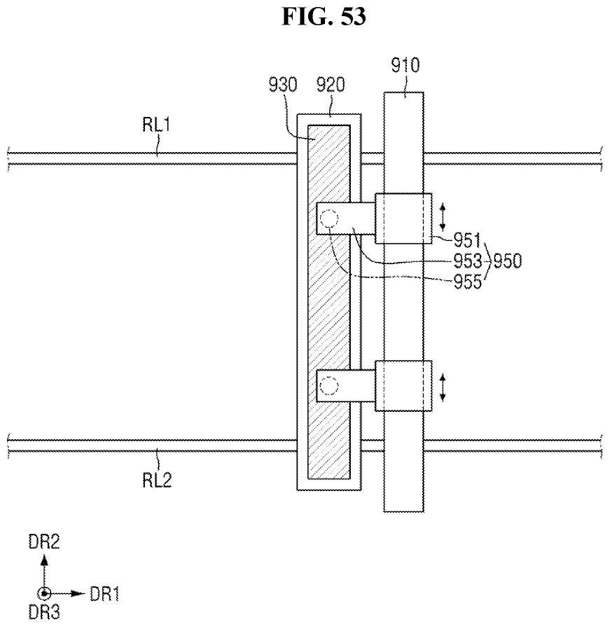

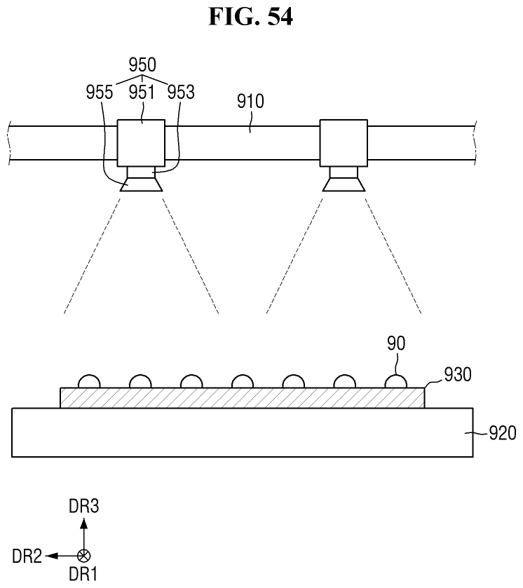

FIG. 52 is a schematic plan view of an inkjet printing device 1000_2 according to an embodiment. FIG. 53 is a schematic plan layout view of second inspection units 950 and an inspection stage unit 920 of the inkjet printing device 1000_2 of FIG. 52. FIG. 54 is a schematic cross-sectional layout view of the second inspection units 950 and the inspection stage unit 920 of the inkjet printing device 1000_2 of FIG. 52.

Referring to FIGS. 52-54, the inkjet printing device 1000_2 according to the current embodiment is different from the inkjet printing device 1000 of FIG. 1 in that it further includes the inspection stage unit 920, an inspection substrate 930, and the second inspection units 950.

The inspection stage unit 920 may provide a space in which the inspection substrate 930 is disposed. The inspection stage unit 920 may be disposed on first and second rails RL1 and RL2. The inspection stage unit 920 may reciprocate on the first and second rails RL1 and RL2 along the first direction DR1. The inspection stage unit 920 may reciprocate between a print head unit 100 and the second inspection units 950.

The inspection substrate 930 may be disposed on the inspection stage unit 920. In an embodiment, the inspection substrate 930 may be glass or film, but the type of the inspection substrate 930 is not particularly limited. For example, the inspection substrate 930 may be an organic film or a transparent glass substrate.

The second inspection units 950 may analyze ink 90 sprayed from the print head unit 100 onto the inspection substrate 930 and thus coated on the inspection substrate 930 and find out the amount of droplets and impact position of the ink 90 sprayed from the print head unit 100.

The inkjet printing device 1000_2 may further include a second support 910. The second support 910 may include a second horizontal support part 911 extending in the second direction DR2 which is a horizontal direction and second vertical support parts 912 connected to the second horizontal support part 911 and extending in the third direction DR3 which is a vertical direction. The direction in which the second horizontal support part 911 extends may be the same as the second direction DR2 perpendicular to the first direction DR1 in which the inspection stage unit 920 moves on the first and second rails RL1 and RL2 in a plan view. The second inspection units 950 may be mounted on the second horizontal support part 911.

Each of the second inspection units 950 may include a first moving part 951, a first support part 953 disposed on a surface of the first moving part 951, and a first sensor part 955 disposed on the first support part 953.

The first moving part 951 may be mounted on the second horizontal support part 911 of the second support 910 to move in the second direction DR2 in which the second horizontal support part 911 extends. As the first moving part 951 moves along the second direction DR2, the first support part 953 mounted on the first moving part 951 may also move in the second direction DR2.

The first support part 953 may be disposed on a lower surface of the first moving part 951 to extend in the first direction DR1. An end of the first support part 953 may be connected to the first moving part 951, and the other end may be connected to the first sensor part 955.

The first sensor part 955 may be disposed above the inspection stage unit 920. The first sensor part 955 may be mounted on the first support part 953 and spaced from the inspection stage unit 920 by a distance (e.g., a set or predetermined distance). The first sensor part 955 may be disposed above the inspection stage unit 920 to detect materials (e.g., set or predetermined materials) coated on the inspection substrate 930 disposed on the inspection stage unit 920. The materials coated on the inspection substrate 930 may be the ink 90. The first sensor part 955 may detect or photograph the materials (e.g., set or predetermined materials) coated on each area of the inspection substrate 930 as the first moving part 951 moves in the second direction DR2.

In an embodiment, the first sensor part 955 may be a high-resolution camera. When the first sensor part 955 is a high-resolution camera, it may be placed above the inspection substrate 930 coated with the ink 90 to photograph the inspection substrate 930 disposed under the first sensor part 955 and measure diameters or positions of droplets of the ink 90 coated on the inspection substrate 930 and an error between them (e.g., determine an error based on the diameters of the droplets of the ink 90 and the distance between two adjacent droplets of the ink 90.

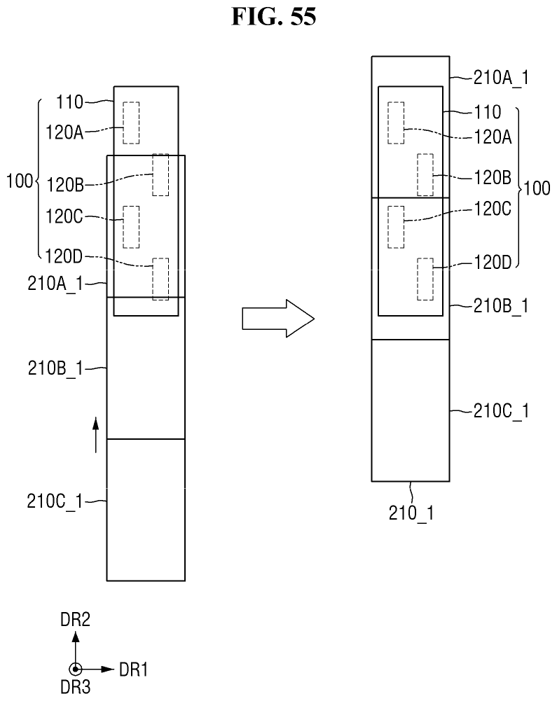

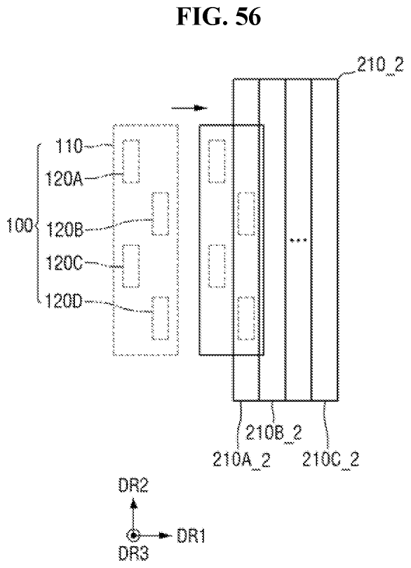

FIG. 55 is a plan layout view of a first suction device 210_1 and a print head unit 100 according to an embodiment. FIG. 56 is a plan layout view of a first suction device 210_2 and a print head unit 100 according to an embodiment.

Each of the first suction devices 210_1 and 210_2 illustrated in FIGS. 55 and 56 may include a plurality of suction parts having different suction powers along the first direction DR1 or the second direction DR2.

For example, referring to FIG. 55, the first suction device 210_1 according to the current embodiment may include a first suction part 210A_1, a second suction part 2106_1, and a third suction part 210C_1 which respectively generate a first negative pressure, a second negative pressure, and a third negative pressure different from each other. The first suction device 210_1 including the first through third suction parts 210A_1 through 210C_1 which generate different negative pressures may adjust the intensity of negative pressure (or suction power) step by step.

The first through third suction parts 210A_1 through 210C_1 may be arranged along the second direction DR2. For example, the first through third suction parts 210A_1 through 210C_1 may be sequentially arranged from top to bottom in a plan view.

The first suction device 210_1 may move along the second direction DR2. The first suction device 210_1 may move along the second direction DR2 to make inkjet heads 120 requiring a suction process overlap one of the first through third suction parts 210A_1 through 210C_1 which generates an appropriate negative pressure and then may perform a suction process.

For example, the inkjet heads 120 may include first through fourth inkjet heads 120A through 120D, and a suction process may need to be performed on the third and fourth inkjet heads 120C and 120D with the second negative pressure. In this case, the first suction device 210_1 may move along the second direction DR2 to make the second suction part 210B_1 generating the second negative pressure overlap the third and fourth inkjet heads 120C and 120D and then may perform a suction process.

Next, referring to FIG. 56, the first suction device 210_2 according to the current embodiment may include a first suction part 210A_2, a second suction part 210B_2, and a third suction part 210C_2 which respectively generate a first negative pressure, a second negative pressure, and a third negative pressure different from each other. The first suction device 210_2 of FIG. 56 including the first through third suction parts 210A_2 through 210C_2 which generate different negative pressures may adjust the intensity of negative pressure (or suction power) step by step.

The first through third suction parts 210A_2 through 210C_2 may be arranged along the first direction DR1. For example, the first through third suction parts 210A_2 through 210C_2 may be sequentially arranged from left to right in a plan view.

Inkjet heads 120 may move along the first direction DR1 above the first suction device 210_2 to above a suction part that generates a negative pressure suitable for a suction process of the inkjet heads 120.

For example, the inkjet heads 120 may include first through fourth inkjet heads 120A through 120D, and a suction process may need to be performed on the second and fourth inkjet heads 120B and 120D with the first negative pressure. In this case, the print head unit 100 may move along the second direction DR2 to make the second and fourth inkjet heads 120B and 120D arranged in the same row overlap the first suction part 210A_2 generating the first negative pressure and then may perform a suction process.

Because each of the suction devices 210_1 and 210_2 of FIGS. 55 and 56 includes a plurality of suction parts that generate different negative pressures, a suction process can be performed using a suction part that generates a negative pressure suitable for inkjet heads requiring a suction process.

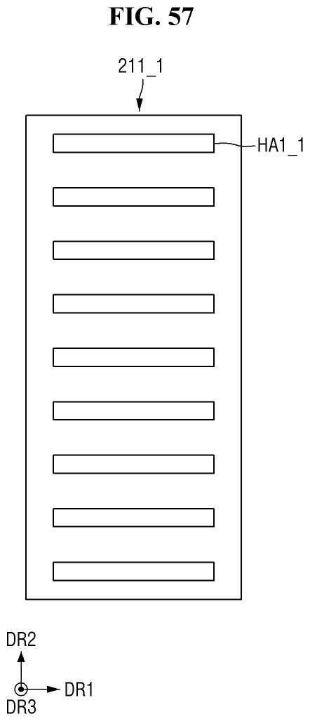

FIGS. 57-59 are plan views illustrating various examples of suction holes formed in a suction body.

Referring to FIG. 57, a plurality of suction holes HA1_1 formed in a suction body 211_1 according to the current embodiment may extend along the first direction DR1. The suction holes HA1_1 formed along the first direction DR1 may be spaced from each other along the second direction DR2. Although nine suction holes HA1_1 are formed in one suction body 211_1 in the drawing, the number of suction holes HA1_1 is not limited thereto.

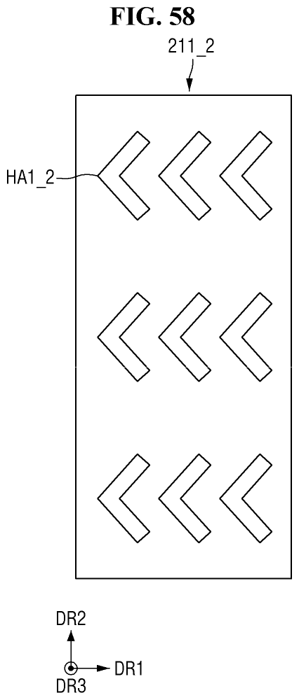

Referring to FIG. 58, a plurality of suction holes HA1_2 formed in a suction body 211_2 according to the current embodiment may have a ‘<’ shape in a plan view. The suction holes HA1_2 may be arranged in in rows and columns (e.g., rows and columns of a matrix shape). The suction holes HA1_2 may be spaced from each other along the first direction DR1 and the second direction DR2. Although a total of nine suction holes HA1_2 are arranged in a 3×3 matrix form in one suction body 211_2 in the drawing, the number and arrangement of the suction holes HA1_2 are not limited thereto.

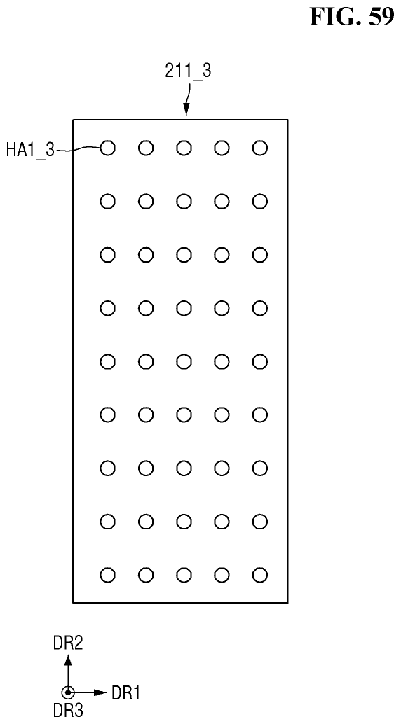

Referring to FIG. 59, a suction body 211_3 according to the current embodiment may include a porous pad made of a porous material including a plurality of pores HA1_3. When the suction body 211_3 includes a porous pad made of a porous material, a diameter of each of the pores HA1_3 may be greater than a maximum length of ink 90 so that particles 95 included in the ink 90 can pass through the pores HA1_3.

In concluding the detailed description, those skilled in the art will appreciate that many variations and modifications can be made to the embodiments without substantially departing from the principles of the present disclosure. Therefore, the described embodiments of the present disclosure are used in a generic and descriptive sense only and not for purposes of limitation.

What is claimed is:

1. An inkjet printing device comprising:
a stage comprising a substrate mounting part configured to receive a target substrate mounted thereon;
a print head unit located above the stage and configured to spray an ink comprising a plurality of particles; and
a suction device located at a side of the substrate mounting part and configured to generate negative pressure thereon.

2. The inkjet printing device of claim 1, further comprising a moving unit to adjust relative positions of the print head unit and the stage, wherein the moving unit is configured to adjust a relative position of the print head unit between above the suction device and above the substrate mounting part.

3. The inkjet printing device of claim 2, wherein the suction device is configured to be driven when the print head unit is positioned above the suction device to generate negative pressure between the suction device and the print head unit.

4. The inkjet printing device of claim 3, wherein at least some of the particles in the ink remaining in the print head unit are sucked into the suction device when the suction device is driven.

5. The inkjet printing device of claim 4, wherein suction of the particles by the suction device is performed in a non-spray mode of the print head unit.

6. The inkjet printing device of claim 5, wherein the suction of the particles by the suction device is performed while the relative positions of the print head unit and the stage are fixed.

7. The inkjet printing device of claim 1, further comprising a preliminary jetting area located between the substrate mounting part and the suction device.

8. The inkjet printing device of claim 7, wherein the preliminary jetting area is located on the stage and spaced from the substrate mounting part.

9. The inkjet printing device of claim 8, wherein the preliminary jetting area comprises an absorption pad to absorb the ink.

10. The inkjet printing device of claim 7, further comprising a dummy area located between the substrate mounting part and the preliminary jetting area.

11. The inkjet printing device of claim 10, wherein the dummy area is located on the stage and spaced from the substrate mounting part.

12. The inkjet printing device of claim 11, wherein the dummy area comprises a dummy part comprising a first roll, a second roll spaced from the first roll, and a dummy film wound around the first roll and the second roll and configured to move according to a rotation of the first roll and the second roll, wherein the print head unit is to spray the ink onto the dummy film.

13. An inkjet printing method comprising:
mounting a target substrate on a substrate mounting part of a stage;
performing suction of at least some of a plurality of particles in an ink remaining in a print head unit in a state where the print head unit configured to spray the ink comprising the particles is located above a side of the substrate mounting part not overlapping the substrate mounting part; and
spraying the ink comprising the particles onto the target substrate by changing relative positions of the stage and the print head unit so that the print head unit is positioned above the target substrate.

14. The method of claim 13, wherein the suction of the particles is performed using a suction device located at a side of the substrate mounting part and configured to generate negative pressure thereon.

15. The method of claim 14, further comprising pre-jetting the ink comprising the particles to a preliminary jetting area located between the substrate mounting part and the suction device, wherein the pre-jetting of the ink is performed between the suction of the particles and the spraying of the ink onto the target substrate.

16. The method of claim 15, wherein the preliminary jetting area is located on the stage and spaced from the substrate mounting part.

17. The method of claim 15, further comprising inspecting the ink sprayed from the print head unit, wherein the inspecting of the ink is performed between the pre-jetting of the ink and the spraying of the ink onto the target substrate.

18. The method of claim 17, wherein the inspecting of the ink comprises spraying the ink comprising the particles to a dummy area located between the substrate mounting part and the preliminary jetting area and inspecting the ink sprayed to the dummy area.

19. The method of claim 13, wherein the suction of the particles is performed in a non-spray mode of the print head unit.

20. The method of claim 13, wherein the suction of the particles is performed while the relative positions of the print head unit and the stage are fixed.
